(19) United States
(12) Patent Application Publication
(10) Pub. No.: US 2018/0242515 A1
(43) Pub. Date: Aug. 30, 2018

(54) FARM FIELD MANAGEMENT SYSTEM, FARM FIELD MANAGEMENT METHOD, AND FARM EQUIPMENT SYSTEM

(71) Applicant: SONY CORPORATION, Tokyo (JP)

(72) Inventors: Masakazu YAJIMA, Saitama (JP); Takayuki HIRABAYASHI, Tokyo (JP); Shinji KOMIYAMA, Tokyo (JP); Yasushi IHARA, Kanagawa (JP); Hideo NIIKURA, Tokyo (JP)

(73) Assignee: Sony Corporation, Tokyo (JP)

(21) Appl. No.: 15/753,043

(22) PCT Filed: Aug. 12, 2016
(86) PCT No.: PCT/JP2016/073708

§ 371 Date: Feb. 15, 2018

(30) Foreign Application Priority Data
Aug. 25, 2015 (JP) 2015-165651

(51) Int. Cl. A01C 7/10; A01B 79/00

(52) U.S. Cl. CPC A01C 7/105; A01B 79/005

(57) ABSTRACT

The present technology relates to a farm field management system, a farm field management method, and a farm equipment system for improving the efficiency of farm work.

A sensor position calculating section calculates a sensor position at which a sensor is deployed on a farm field on the basis of farm field information. A sensor deployment controlling section controls a sensor deploying mechanism that deploys the sensor on the farm field to deploy the sensor in accordance with the sensor position. The present technology may be applied to a farm field management system that manages the farm field or to a farm equipment system that performs farm work on the farm field.

### TECHNICAL FIELD

The present technology relates to a farm field management system, a farm field management method, and a farm equipment system. More particularly, the technology relates to a farm field management system, a farm field management method, and a farm equipment system for improving the efficiency of farm work.

### BACKGROUND ART

PTL 1 discloses a data collection network for agricultural applications. In this network, energy harvest sensors for farm use are driven typically by radio waves from a base unit.

### CITATION LIST

### Patent Literature

### [PTL 1]

U.S. Patent Application Publication No. 2014/0024313

### SUMMARY

### Technical Problem

However, PTL 1 fails to describe how the sensors are to be deployed on the farm field.

The present technology has been devised in view of the above circumstances. An object of the technology is to improve the efficiency of farm work.

### Solution to Problem

According to one aspect of the present technology, there is provided a farm field management system including: a sensor position calculating section configured to calculate a sensor position at which a sensor is deployed on a farm field on the basis of farm field information; and a sensor deployment controlling section configured to control a sensor deploying mechanism that deploys the sensor on the farm field to deploy the sensor in accordance with the sensor position.

The farm field management system may further include an instruction information generating section configured to generate instruction information for causing the sensor deploying mechanism to deploy the sensor in accordance with the sensor position calculated by the sensor position calculating section. The sensor deployment controlling section may be caused to cause the sensor deploying mechanism to deploy the sensor in accordance with the generated instruction information.

The farm field management system may further include a sensor communication section configured to communicate with the sensor deployed by the sensor deploying mechanism in order to acquire a sensor ID of the sensor.

The farm field management system may further include a log generating section configured to generate a sensor deployment log including the sensor ID of the sensor in communication and a sensor deployment position at which the sensor is deployed.

The sensor deployment log may include a timestamp indicative of a date and a time at which the sensor has been deployed and a sensor type indicative of the deployed sensor.

The farm field management system may further include a storage section configured to store the generated sensor deployment log.

The farm field management system may further include: a farm machine configured to have a farm machine mount sensor for acquiring the farm field information on the farm field; and an implement configured to be connected with the farm machine and include the sensor deploying mechanism. The sensor position calculating section may be caused to calculate the sensor position following the acquisition of the farm field information by the farm machine mount sensor of the farm machine. The sensor deployment controlling section may be caused to cause the sensor deploying mechanism of the implement to deploy the sensor following the calculation of the sensor position by the sensor position calculating section.

The farm machine mount sensor may be caused to acquire as the farm field information image data representing a crop as an object. The sensor position calculating section may be caused to calculate the sensor position based on a positional relation between the crop on the one hand and the farm machine and the implement on the other hand, the positional relation being calculated through analysis of the image data.

The farm machine mount sensor may be caused to acquire as the farm field information data about moisture and nutrients in the soil. The sensor position calculating section may be caused to calculate the sensor position based on the data about the moisture and the nutrients.

The farm field management system may further include a seeding position calculating section configured to calculate a seeding position for a crop on the farm field on the basis of the farm field information.

The farm field management system may further include a seeding mechanism configured to seed the crop in accordance with the seeding position in parallel with the deployment of the sensor by the sensor deploying mechanism.

The farm field management system may further include a log generating section configured to generate a seeding log including a crop ID of the seeded crop and the seeding position at which the crop has been seeded.

The farm field management system may further include a display section configured to display a screen indicative of deployment status of the sensor on the farm field.

The display section may be caused to update the display on the screen every time the sensor is deployed.

The sensor may include: a sensor substrate configured to communicate with the sensor communication section; a capsule configured to be spherical in shape to encapsulate the sensor substrate; and a weight configured to be disposed inside the capsule to keep the sensor substrate constant in attitude.

According to another aspect of the present technology, there is provided a farm field management method including the steps of: calculating a sensor position at which a sensor is deployed on a farm field on the basis of farm field information; and controlling a sensor deploying mechanism that deploys the sensor on the farm field to deploy the sensor in accordance with the sensor position.

According to a further aspect of the present technology, there is provided a farm equipment system in which an information processing apparatus includes a sensor position calculating section configured to calculate a sensor position at which a sensor is deployed on a farm field on the basis of farm field information; and an implement includes a sensor deployment controlling section configured to control a sensor deploying mechanism that deploys the sensor on the farm field to deploy the sensor in accordance with the sensor position.

According to the above-mentioned aspects of the present technology, a sensor position at which a sensor is deployed on the farm field is calculated on the basis of farm field information. The sensor is then deployed by a sensor deploying mechanism that deploys the sensor on the farm field in accordance with the sensor position.

### Advantageous Effect of Invention

According to one aspect of the present technology, it is possible to improve the efficiency of farm work.

### BRIEF DESCRIPTION OF DRAWINGS

FIG. 1 is a schematic diagram depicting a typical configuration of a farm field management system to which the present technology is applied.

FIG. 2 is a perspective diagram depicting a typical structure of a sensor.

FIG. 3 is a cross-sectional diagram depicting a typical structure of the sensor.

FIG. 4 is a cross-sectional diagram depicting another typical structure of the sensor.

FIG. 5 is a cross-sectional diagram depicting still another typical structure of the sensor.

FIG. 6 is a schematic diagram depicting a typical hardware configuration of a farm equipment system.

FIG. 7 is a schematic diagram explaining the deployment of sensors.

FIG. 8 is another schematic diagram explaining the deployment of sensors.

FIG. 9 is a block diagram depicting a typical functional configuration of the farm equipment system.

FIG. 10 is a flowchart explaining a work instruction information generating process.

FIG. 11 is a tabular view depicting typical work instruction information.

FIG. 12 is a schematic diagram depicting a typical screen display based on work instruction information.

FIG. 13 is a flowchart explaining a sensor deploying process.

FIG. 14 is a tabular view depicting a typical sensor deployment log.

FIG. 15 is a schematic diagram depicting a typical screen display indicating work status.

FIG. 16 is a tabular view depicting a typical seeding log.

FIG. 17 is a block diagram depicting a typical functional configuration of the farm field management system.

FIG. 18 is a schematic diagram explaining the operation of the farm equipment system using real-time sensing.

FIG. 19 is a flowchart explaining another sensor deploying process.

FIG. 20 is a block diagram depicting another typical functional configuration of the farm field management system.

FIG. 21 is a flowchart explaining a sensor data acquiring process.

FIG. 22 is a schematic diagram explaining a travel route at the time of acquiring sensor data.

FIG. 23 is a tabular view depicting a typical sensor data log.

FIG. 24 is a flowchart explaining a work information generating process.

FIG. 25 is a schematic diagram explaining a work map.

FIG. 26 is another schematic diagram explaining the work map.

FIG. 27 is another schematic diagram explaining the work map.

FIG. 28 is another schematic diagram explaining the work map.

FIG. 29 is a tabular view depicting typical work information.

FIG. 30 is a tabular view depicting another typical sensor data log.

FIG. 31 is a flowchart explaining a work process.

FIG. 32 is a block diagram depicting another typical functional configuration of the farm equipment system.

FIG. 33 is a flowchart explaining another work process.

FIG. 34 is a schematic diagram explaining a position offset between a sensor communication section and a work mechanism.

FIG. 35 is a block diagram depicting a typical functional configuration of the sensor.

FIG. 36 is a block diagram depicting another typical functional configuration of the sensor.

FIG. 37 is a block diagram depicting still another typical functional configuration of the sensor.

FIG. 38 is a block diagram depicting still another typical functional configuration of the sensor.

FIG. 39 is a schematic diagram depicting a typical format of sensor data.

FIG. 40 is a block diagram depicting a typical functional configuration of a wireless communication system.

FIG. 41 is a flowchart explaining a distance calculating process.

FIG. 42 is a tabular view explaining attenuation coefficients and additional losses.

FIG. 43 is a block diagram depicting another typical functional configuration of the wireless communication system.

FIG. 44 is a flowchart explaining a distance calculating process.

FIG. 45 is a block diagram depicting still another typical functional configuration of the wireless communication system.

FIG. 46 is a flowchart explaining another distance calculating process.

FIG. 47 is a block diagram depicting still another typical functional configuration of the wireless communication system.

FIG. 48 is a flowchart explaining a status estimating process.

FIG. 49 is a graphic chart plotting the relation between frequencies and attenuation constants.

FIG. 50 is a block diagram depicting still another typical configuration of the farm equipment system.

FIG. 51 is a flowchart explaining a sensor recovering process.

FIG. 52 is a schematic diagram explaining a travel route at the time of recovering sensors.

FIG. 53 is a flowchart explaining an unrecovered sensor recovering process.

FIG. 54 is a schematic diagram explaining a travel route at the time of the unrecovered sensor recovering process.

FIG. 55 is a block diagram depicting still another typical functional configuration of the farm field management system.

### DESCRIPTION OF EMBODIMENTS

Some preferred embodiments of the present technology are described below with reference to the accompanying drawings. The description will be made under the following headings:

1. Outline of the farm field management system
2. Deployment of the sensors
3. Utilization of sensor data
4. Details of power generation by and communication with the sensors
5. Recovery of the sensors

### <1. Outline of the Farm Field Management System>

### (Typical Configuration of the Farm Field Management System)

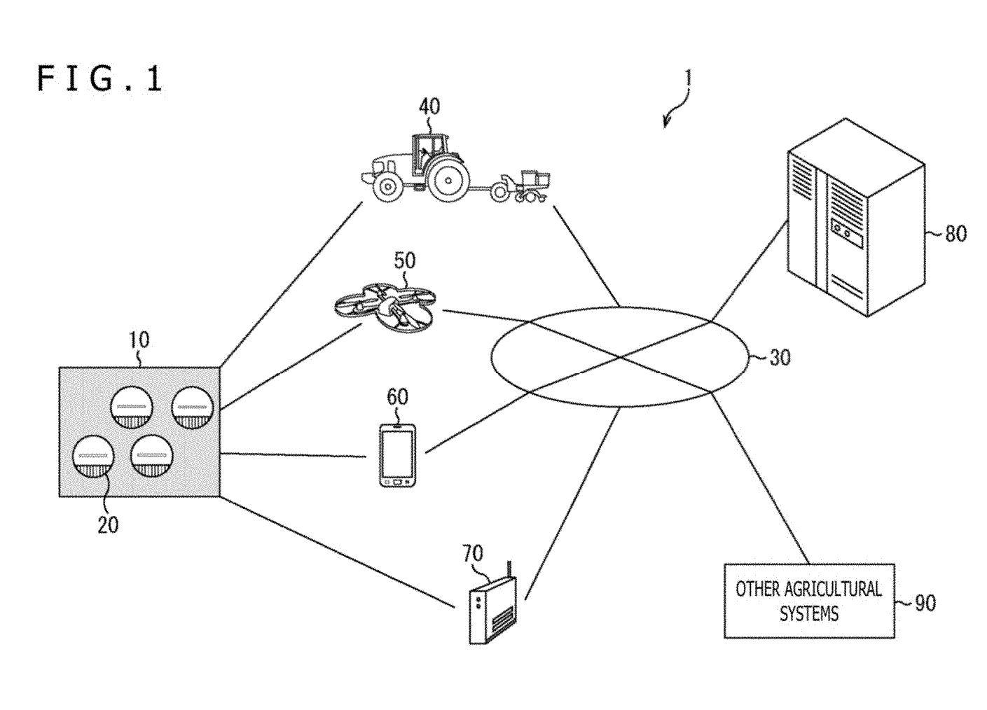

FIG. 1 depicts a typical configuration of a farm field management system to which the present technology is applied.

A farm field management system 1 includes multiple sensors 20 deployed on a farm field 10, a network 30, a farm equipment system 40, a mobile object 50, a terminal apparatus 60, a repeater 70, a server 80, and other agricultural systems 90.

The sensors 20 each include an energy harvest sensor. The sensors 20 collect energy such as sunlight, heat, vibrations, or radio waves and converts what is collected into electric power. Driven by power from the conversion, the sensors 20 output data reflecting their status by communicating wirelessly with an external device.

In this manner, the sensors 20 acquire farm field-related data through sensing and transmit the acquired data. The sensors 20 may also be configured to transmit the generated power itself as the sensing data. The sensors 20 may also be configured to drive other diverse sensors such as soil sensors using the generated power, acquire sensing data from these sensors, and transmit the acquired sensing data.

Note that the power source of the sensors 20 is not limited to harvested energy. As the power source of the sensors 20, harvested energy may be supplemented or replaced with a battery mounted to transmit the sensing data.

The network 30 includes wireless communication channels such as a 4G (4th Generation) network or satellite channels. The network 30 is connected with the farm equipment system 40, mobile object 50, terminal apparatus 60, repeater 70, server 80, and other agricultural systems 90.

The farm equipment system 40 includes a farm machine such as a tractor, a control console attached to the farm machine, and an implement with mechanisms for work on the farm. The farm equipment system 40 performs seeding and transplanting of a crop on the farm field 10 and deploys the sensors 20 on the farm field 10. Also, the farm equipment system 40 harvests the crop and recovers the sensors 20. While moving across the farm field 10, the farm equipment system 40 can communicate with the sensors 20 deployed on the farm field 10. As needed, the farm equipment system 40 supplies the server 80 via the network 30 with the information obtained from communication with the sensors 20.

The mobile object 50 has a mechanism capable of traveling across the farm field 10. For example, the mobile object 50 may be a flying object with a flying mechanism (e.g., a drone equipped with multiple rotors) or a vehicle with a traveling mechanism. While traveling across the farm field 10, the mobile object 50 can also communicate with the sensors 20 deployed on the farm field 10. As needed, the mobile object 50 supplies the server 80 via the network 30 with the information obtained from communication with the sensors 20.

The terminal apparatus 60 typically includes a mobile terminal (e.g., smartphone) or a personal computer. The terminal apparatus 60 is operated by the user managing the farm field 10, for example. The terminal apparatus 60 supplies the server 80 via the network 30 with information related to the farm field (farm field information), among others, input through operation by the user.

The repeater 70 has the function of relaying wireless communication between the network 30 on the one hand and the farm equipment system 40, mobile object 50, and terminal apparatus 60 on the other hand.

On the basis of information from the sensors 20 and terminal apparatus 60, the server 80 performs processes aimed at deploying the sensors 20 on the farm field 10, utilizing the data output from the sensors 20, and recovering the sensors 20.

The other agricultural systems 90 include, for example, a farm work management system for managing the status of farm work and a watering system for supplying water to the farm field. Each component system of the other agricultural systems 90 also performs its own processes based on the information from the sensors 20 and terminal apparatus 60.

### (Structure of the Sensor)

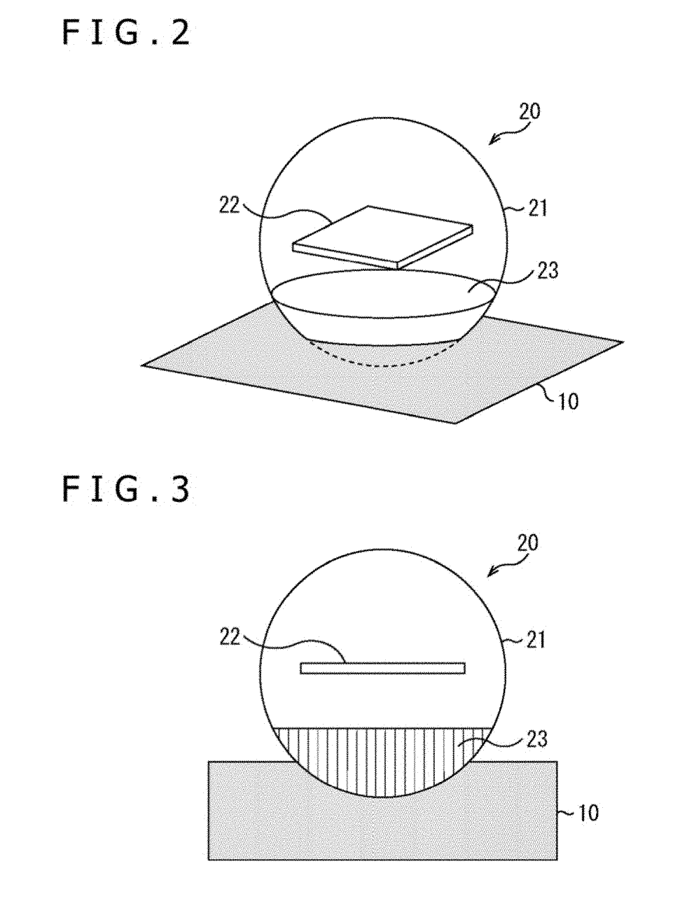

The structure of each sensor 20 is explained below. FIG. 2 depicts a perspective diagram of a sensor 20, and FIG. 3 indicates a cross-sectional diagram of the sensor 20.

The sensor 20 includes a capsule 21, a sensor substrate 22, and a weight 23.

The capsule 21 is spherically shaped by resin, for example. The sensor substrate 22 is enclosed inside the capsule 21.

The sensor substrate 22 is configured to communicate wirelessly with external devices.

The weight 23 is placed inside the capsule 21 in such a manner that the substrate surface of the sensor substrate 22 will remain horizontal.

Structured in this manner, the multiple sensors 20 deployed on the farm field 10 allow their sensor substrates 22 to stay constant in attitude. The structure further enables each sensor 20 to communicate uniformly with external devices.

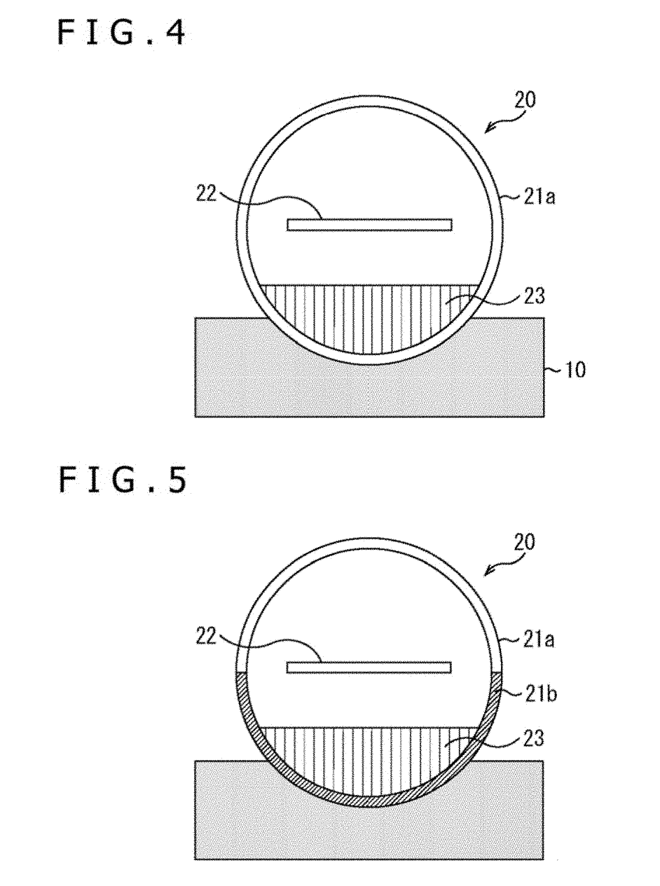

FIG. 4 is a cross-sectional diagram depicting another typical structure of the sensor 20.

The sensor 20 depicted in FIG. 4 includes a capsule 21a, the sensor substrate 22, and the weight 23.

The capsule 21a has a two-layer cross-section structure. There is a narrow gap between the inner and the outer layers of the capsule 21a. The inner layer of the capsule 21a is housed in a smoothly rotatable manner inside the outer layer.

Even when the sensors 20 are deployed on the farm field 10 in such a manner that the substrate surface of their sensor substrates 22 is tilted with respect to a horizontal plane, the capsule structure allows the substrate surface of the sensor substrates 22 to regain a horizontal state.

Also, as depicted in FIG. 5, a liquid 21b may be enclosed in the gap between the inner and the outer layers of the capsule 21a. The liquid 21b allows the inner layer of the capsule 21a to rotate more smoothly inside the outer layer.

The liquid 21b is adjusted in quantity so that the liquid surface comes lower than the surface of the sensor substrate 22 as viewed cross-sectionally. This is intended not to attenuate the radio waves of wireless communication by the sensor substrate 22.

### (Configuration of the Farm Equipment System)

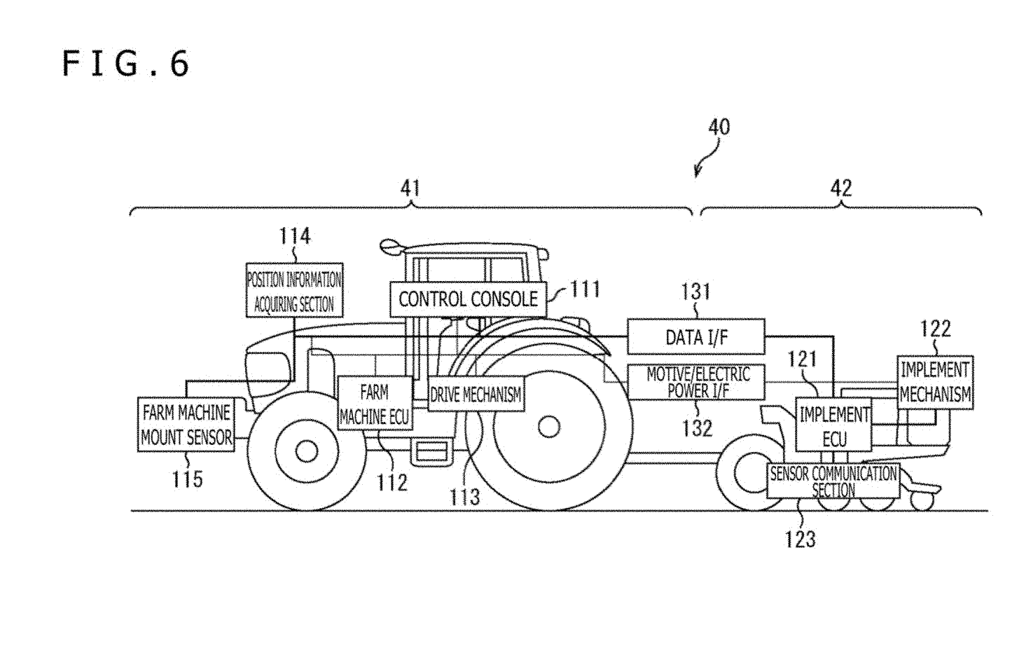

A typical hardware configuration of the farm equipment system 40 is explained below with reference to FIG. 6.

As depicted in FIG. 6, the farm equipment system 40 is constituted with an implement 42 hitched behind a farm machine 41.

The farm machine 41 includes an agricultural tractor. The farm machine 41 controls the entire farm equipment system 40 and has the power to travel across the farm field 10.

Specifically, the farm machine 41 includes a control console 111, a farm machine ECU (Electric Control Unit) 112, a drive mechanism 113, a position information acquiring section 114, and a farm machine mount sensor 115.

The control console 111 controls an entire sensing system and a drive train of the farm equipment system 40. The control console 111 is configured as a hardware unit independent of the farm machine 41 and housed in an enclosure removably attached to the farm machine 41, for example.

Under control of the control console 111, the farm machine ECU 112 mainly controls the drive train of the farm machine 41 and particularly the drive mechanism 113.

The drive mechanism 113 includes an engine or a motor, for example. Under control of the farm machine ECU 112, the drive mechanism 113 causes the farm machine 41 to travel by driving its wheels.

The position information acquiring section 114 acquires (measures) the current position of the farm machine 41 with an error of a few centimeters. The position information acquiring section 114 is configured as a receiver of a RTK-GPS (Real Time Kinematic-Global Positioning System), for example.

The farm machine mount sensor 115 acquires information about the environment surrounding the farm machine 41 that is traveling. For example, the farm machine mount sensor 115 is configured as a CMOS (Complementary Metal Oxide Semiconductor) image sensor, a CCD (Charge Coupled Device) image sensor, or an NIR (Near Infrared) sensor having the function of capturing images. Alternatively, the farm machine mount sensor 115 may include a soil sensor sensing in real time the moisture and nutrients in the soil of the farm field. As another alternative, the farm machine mount sensor 115 may be configured as a remote sensing sensor. In this case, the farm machine mount sensor 115 may acquire, via satellites or the like, data indicative of the distribution of vegetation such as an NDVI (Normalized Difference Vegetation Index).

Meanwhile, the implement 42 performs work on the farm field 10.

Specifically, the implement 42 includes an implement ECU 121, an implement mechanism 122, and a sensor communication section 123.

Under control of the control console 111, the implement ECU 121 controls primarily the implement mechanism 122.

The implement mechanism 122 has the function of seeding and transplanting crops on the farm field 10 and harvesting the crops under control of the implement ECU 121. The implement mechanism 122 also has the function of deploying the sensors 20 on the farm field 10 and recovering the deployed sensors 20 under control of the implement ECU 121. Furthermore, the implement mechanism 122 has the function of doing such work as watering and fertilizing on the farm field under control of the implement ECU 121.

The sensor communication section 123 communicates wirelessly with the sensors 20 deployed on the farm field 10. The wireless communication here may be based on a communication method utilizing an M2M communication frequency band such as the 920 MHz band, a communication method utilizing the 2.4 GHz band such as Wi-Fi (registered trademark) or BLE (Bluetooth (registered trademark) Low Energy), or a proximity wireless communication method such as NFC (Near Field Communication).

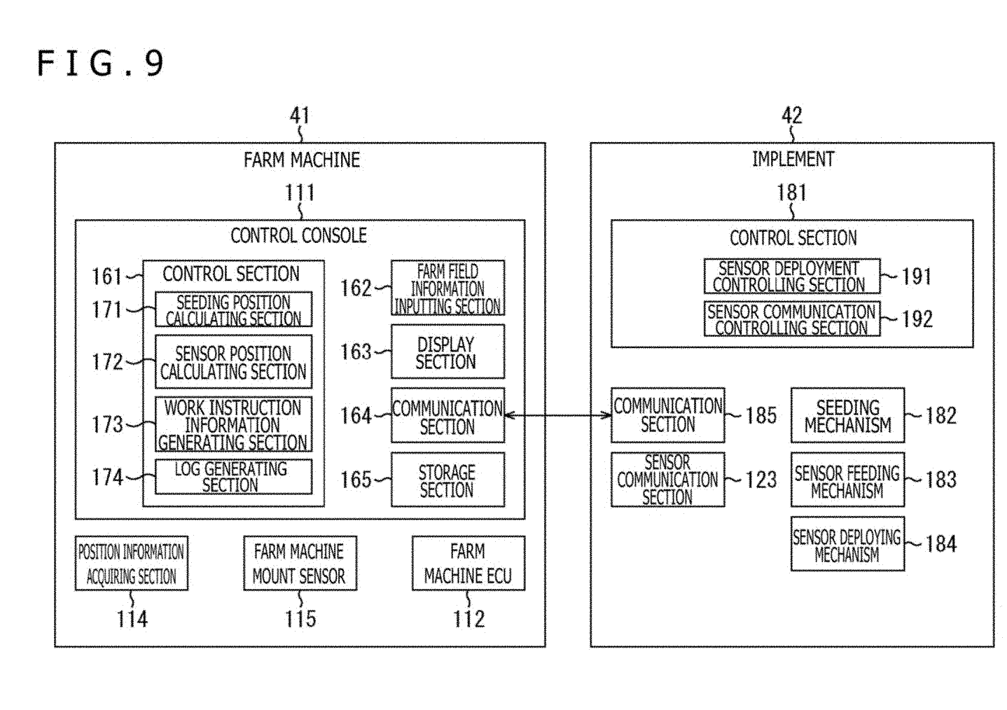

The sensor communication section 123 may communicate not only with the sensors 20 deployed on the farm field 10 but also with the sensors 20 stored in a sensor feeding mechanism 183 (FIG. 9), to be discussed later. At this point, the communication method and the frequency band of the communication with the sensors 20 deployed on the farm field 10 are different from those of the communication with the sensors 20 stored in the sensor feeding mechanism 183. Specifically, since certain distances are required between the sensor communication section 123 and the sensors 20 deployed on the farm field 10, the communication method using the M2M communication frequency band is adopted for communication with the sensors 20 deployed on the farm field 10. On the other hand, NFC is used for communication with the sensors 20 stored in the sensor feeding mechanism 183. Using different communication methods helps reduce the congestion of traffic in communication with numerous sensors 20 stored in a narrow space such as the sensor feeding mechanism 183.

Alternatively, each sensor 20 may be equipped with a communication section similar to the sensor communication section 123. The communication may then be carried out using different communication methods as described above.

Note that, between the farm machine 41 and the implement 42, the components of the sensing system are interconnected by a data I/F (Interface) 131 capable of transferring data in wired or wireless fashion. The components of the power train are interconnected by a motive/electric power I/F 132 such as a power takeoff (PTO).

### <2. Deployment of the Sensors>

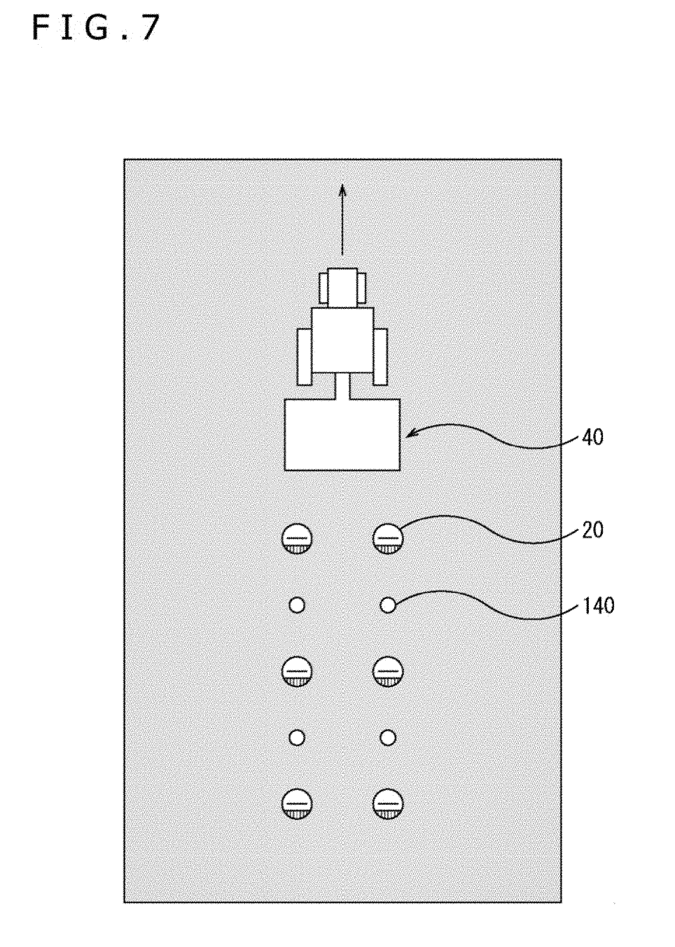

As depicted in FIG. 7, the farm equipment system 40 seeds a crop 140 and deploys the sensors 20 while traveling on the farm field 10. At this point, the farm equipment system 40 records deployment information indicative of the positions of the deployed sensors 20.

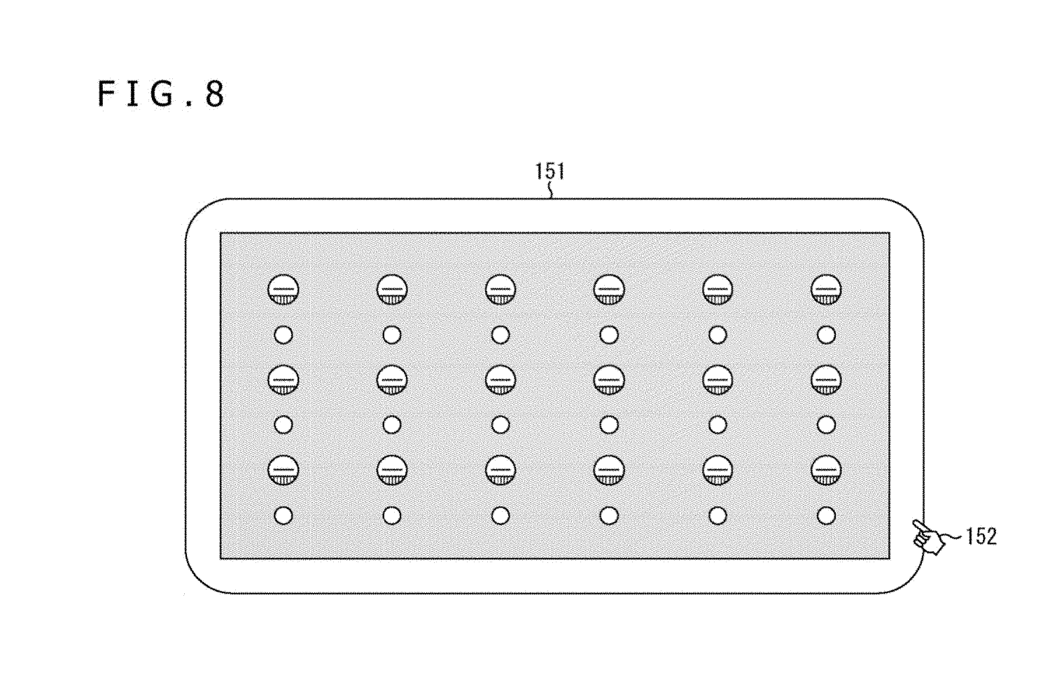

Note that the positions where the crop 140 is seeded (called the seeding positions hereunder) and the positions where the sensors 20 are deployed (called the sensor positions hereunder) may be input by a user 152 operating a touch panel monitor 151 attached to the control console 111 as depicted in FIG. 8. In this case, the seeding positions and sensor positions on the entire farm field 10 may be input manually. Alternatively, only partial patterns of the seeding positions and sensor positions may be input so that the seeding positions and sensor positions on the entire farm field 10 may be automatically calculated.

As another alternative, recommended seeding positions and sensor positions may be calculated on the basis of farm field information, to be discussed later. In this case, the recommended seeding positions and sensor positions are displayed on the touch panel monitor 151 for verification by the user.

### (Typical Functional Configuration of the Farm Equipment System)

Explained below with reference to FIG. 9 is a typical functional configuration of the farm equipment system 40 (farm machine 41 and implement 42) that deploys the sensors. Note that the structures having the similar functions to those discussed above are given the same names and designated by the same reference signs, and these structures will not be discussed further.

The farm machine 41 includes the control console 111, farm machine ECU 112, position information acquiring section 114, and farm machine mount sensor 115.

The control console 111 includes a control section 161, a farm field information inputting section 162, a display section 163, a communication section 164, and a storage section 165.

The control section 161 includes a CPU (Central Processing Unit) and controls the components of the control console 111.

The farm field information inputting section 162 includes a keyboard, buttons, and a touch pad, for example. The farm field information inputting section 162 receives input of farm field information related to the farm field 10 and supplies the input information to the control section 161. For example, the farm field information includes items and varieties of crops to be cultivated on the farm field 10, their cultivation periods, geographical data about the farm field, and information about the soil of the farm field. The farm field information may be input by the user's operations or by wireless communication.

The display section 163 includes a LCD (Liquid Crystal Display) or an organic EL (Electro Luminescent) display, for example. Under control of the control section 161, the display section 163 displays various screens.

Note that the touch panel 151 depicted in FIG. 8 may also include the farm field information inputting section 162 and display section 163.

The communication section 164 communicates with the implement 42 in wired or wireless fashion under control of the control section 161. The communication section 164 may also communicate with other devices via the network 30.

The storage section 165 includes a nonvolatile memory, for example. The storage section 165 stores diverse information and data under control of the control section 161.

Further, the control section 161 includes a seeding position calculating section 171, a sensor position calculating section 172, a work instruction information generating section 173, and a log generating section 174.

The seeding position calculating section 171 calculates seeding positions based on the farm field information input from the farm field information inputting section 162.

The sensor position calculating section 172 calculates sensor positions based on the farm field information input from the farm field information inputting section 162.

The work instruction information generating section 173 generates work instruction information indicative of the detail of work to be performed by the implement 42 on the basis of the calculated seeding positions and sensor positions. Note that the work in this case involves seeding of crops and deployment of the sensors 20.

The log generating section 174 generates a log indicating the detail of work that has been performed by the implement 42.

The implement 42 includes a control section 181, a seeding mechanism 182, the sensor feeding mechanism 183, a sensor deploying mechanism 184, a communication section 185, and the sensor communication section 123.

The control section 181 includes a CPU. The control section 181 controls the components of the implement 42.

The seeding mechanism 182 has the function of seeding crops on the farm field 10.

The sensor feeding mechanism 183 stores multiple sensors 20 inside. The sensor feeding mechanism 183 has the function of feeding the sensors 20 as needed to the sensor deploying mechanism 184.

The sensor deploying mechanism 184 has the function of deploying the sensors 20 as needed on the farm field 10, the sensors 20 being fed from the sensor feeding mechanism 183.

The communication section 185 communicates with the farm machine 41 in wired or wireless fashion under control of the control section 181. The communication section 185 may also communicate with other devices via the network 30.

Further, the control section 181 includes a sensor deployment controlling section 191 and a sensor communication controlling section 192.

The sensor deployment controlling section 191 controls the sensor deploying mechanism 184. Specifically, the sensor deployment controlling section 191 causes the sensor deploying mechanism 184 to deploy the sensors 20 based on the sensor positions calculated by the sensor position calculating section 172.

The sensor communication controlling section 192 controls the sensor communication section 123. Specifically, the sensor communication controlling section 192 causes the sensor communication section 123 to communicate with the sensors 20 deployed on the farm field 10.

### (Work Instruction Information Generating Process)

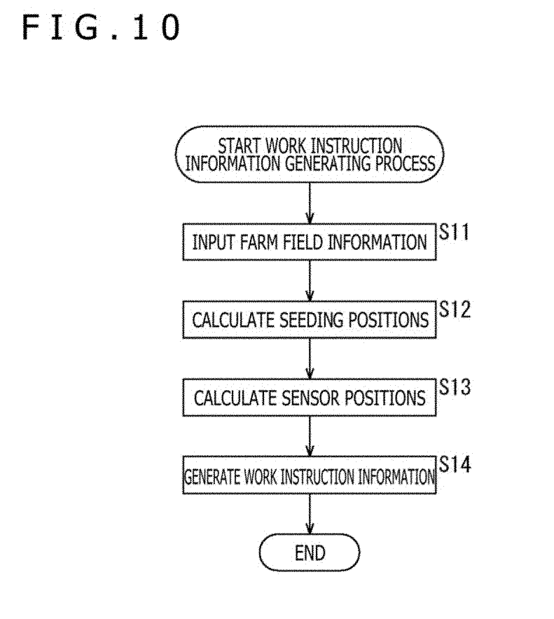

A work instruction information generating process is explained below with reference to the flowchart of FIG. 10.

In step S11, the farm field information inputting section 162 receives input of farm field information and supplies the input information to the control section 161.

In step S12, the seeding position calculating section 171 calculates the seeding positions based on the farm field information input from the farm field information inputting section 162.

In step S13, the sensor position calculating section 172 calculates the sensor positions based on the farm field information input from the farm field information inputting section 162.

In step S14, the work instruction information generating section 173 generates the work instruction information based on the calculated seeding positions and sensor positions.

This is how the work instruction information is generated.

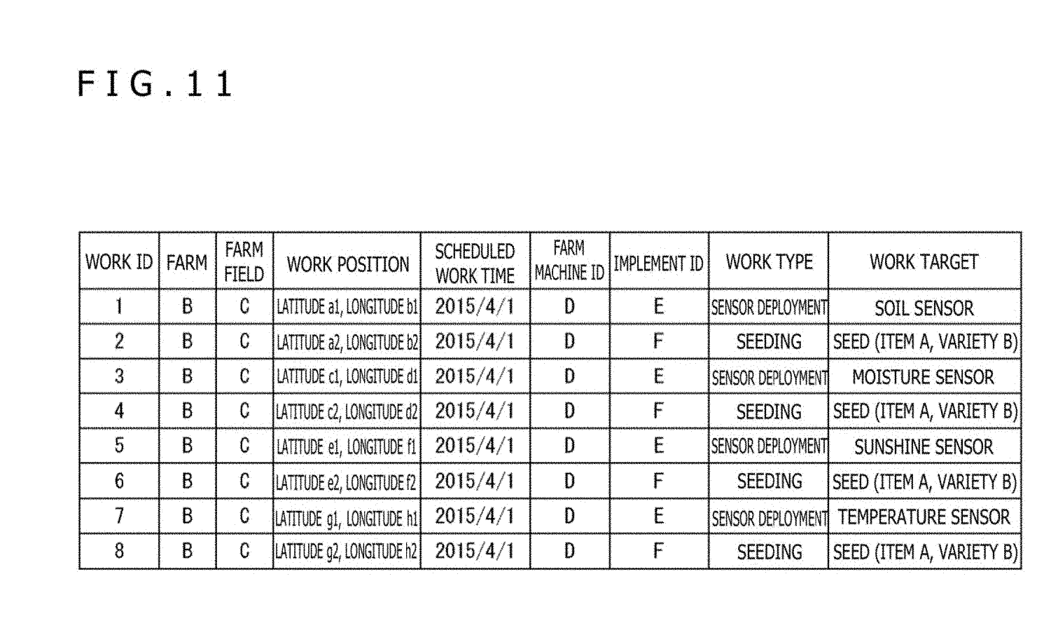

FIG. 11 depicts typical work instruction information.

In the work instruction information, each work ID (Identifier) is associated with eight items of information: a farm, a farm field, a work position, a scheduled work time, a farm machine ID, an implement ID, a work type, and a work target.

The information item “farm” is indicative of the farm (or its owner) where the farm field to be worked on is located.

The information item “farm field” is indicative of the farm field where work is to be performed.

The information item “work position” is indicative of the position (in latitude and longitude) where the work identified by the corresponding work ID is to be performed. The “work positions” are set in accordance with the seeding positions calculated by the seeding position calculating section 171 and the sensor positions calculated by the sensor position calculating section 172. When the current position acquired by the position information acquiring section 114 of the farm machine 41 reaches the position indicated by the “work position,” the work identified by the corresponding work ID is performed.

The information item “scheduled work time” is indicative of the date and time at which the work identified by the corresponding work ID is to be performed.

The information item “farm machine ID” is indicative of the farm machine 41 coupled to the implement 42 performing the work identified by the corresponding work ID.

The information item “implement ID” is indicative of the implement mechanism of the implement 42 performing the work identified by the corresponding work ID. For example, the “implement ID” is the information identifying either the seeding mechanism 182 or the sensor deploying mechanism 184.

The information item “work type” is indicative of the type of work identified by the corresponding work ID. There are two “work types”: “seeding,” to be performed by the seeding mechanism 182, and “sensor deployment,” to be carried out by the sensor deploying mechanism 184.

The information item “work target” is indicative of the target of work identified by the corresponding work ID. If the “work type” is “seeding,” the “work target” is the information indicative of the item and variety of the crop (seed) to be seeded. If the “work type” is “sensor deployment,” the “work target” is the information indicative of the type of sensors to be deployed.

Further, on the basis of the “work position” in the work instruction information, travel route information indicative of the route to be traveled by the farm equipment system 40 may be generated and included into the work instruction information.

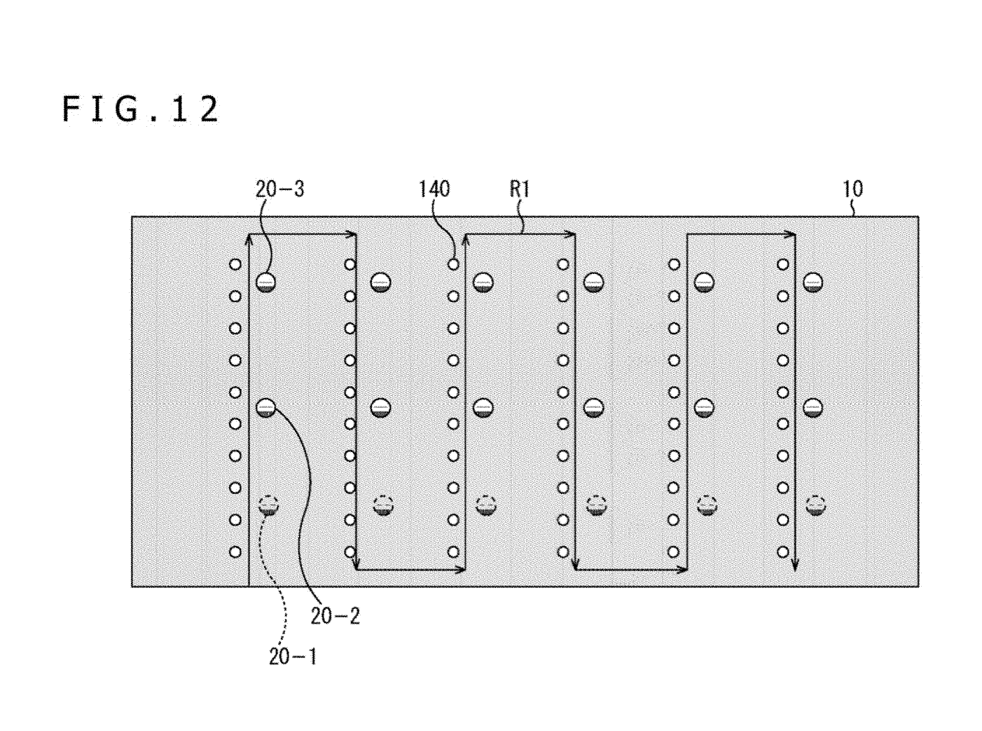

Also, the work instruction information may be transmitted to the terminal apparatus 60 operated by the user managing the farm field 10. In this case, the terminal apparatus 60 displays a screen such as one depicted in FIG. 12.

FIG. 12 depicts a typical screen display based on work instruction information.

What is depicted in FIG. 12 is how the sensors 20 and the crop 140 are deployed on the farm field 10 in accordance with the work instruction information. In particular, FIG. 12 illustrates a sensor 20-1 being buried in the ground and sensors 20-2 and 20-3 being deployed on the ground surface. Also depicted in FIG. 12 are arrows R1 indicative of the route to be traveled by the farm equipment system 40 on the basis of the travel route information.

Such a screen display allows the user to confirm how the sensors are to be deployed.

### (Sensor Deploying Process)

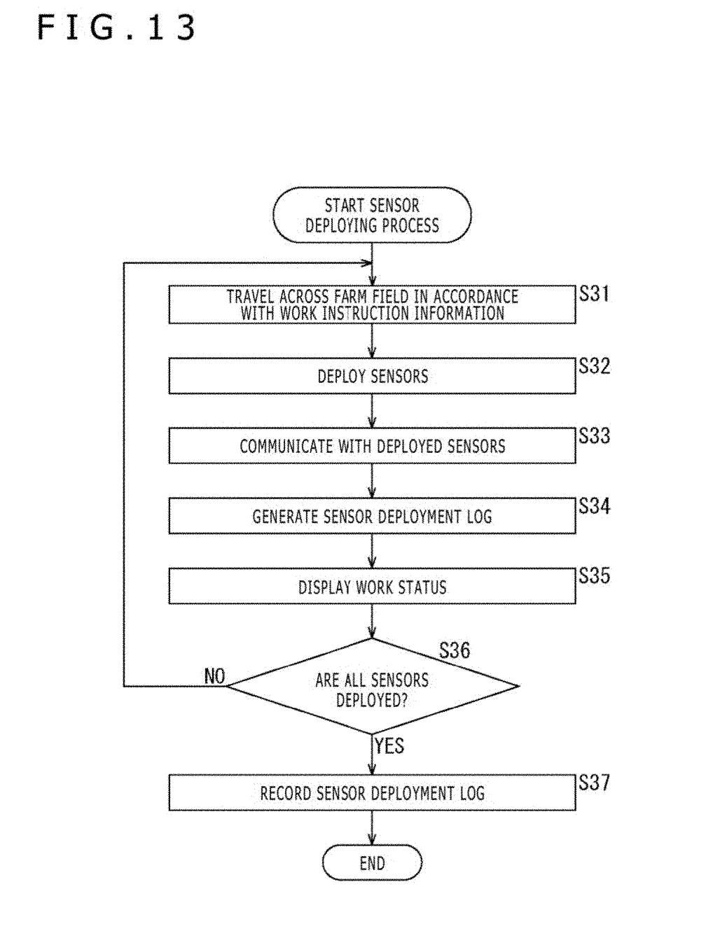

A sensor deploying process is explained below with reference to the flowchart of FIG. 13.

In step S31, the farm equipment system 40 travels across the farm field 10 in accordance with the work instruction information (travel route information).

When the current position acquired by the position information acquiring section 114 of the farm machine 41 reaches the position indicated by the “work position” in the work instruction information, the sensor deployment controlling section 191 in step S32 controls the sensor deploying mechanism 184 to deploy a sensor 20.

Note that the position information acquiring section 114 of the farm machine 41 is disposed at a distance from the sensor deploying mechanism 184 of the implement 42. For this reason, the sensor deployment controlling section 191 causes the sensor 20 to be deployed at the “work position” offset by the distance between the position information acquiring section 114 and the sensor deploying mechanism 184. Specifically, the control section 161 acquires offset information about the sensor deploying position of the sensor deploying mechanism 184 by communication with the implement 42. The control section 161 then adds the offset to the current position acquired by the position information acquiring section 114. Alternatively, the control section 181 of the implement 42 may add the offset regarding the sensor deploying position of the sensor deploying mechanism 184 to the current position information acquired from the farm machine 41.

In step S33, the sensor communication controlling section 192 controls the sensor communication section 123 to communicate with the deployed sensor 20. In this manner, the sensor communication controlling section 192 acquires the sensor ID identifying the sensor 20 and sends the acquired sensor ID to the log generating section 174.

In step S34, the log generating section 174 generates a sensor deployment log based on the operation of the sensor deploying mechanism 184 and on the sensor ID from the sensor communication controlling section 192, the sensor deployment long being deployment information indicative of where the sensor 20 has been deployed.

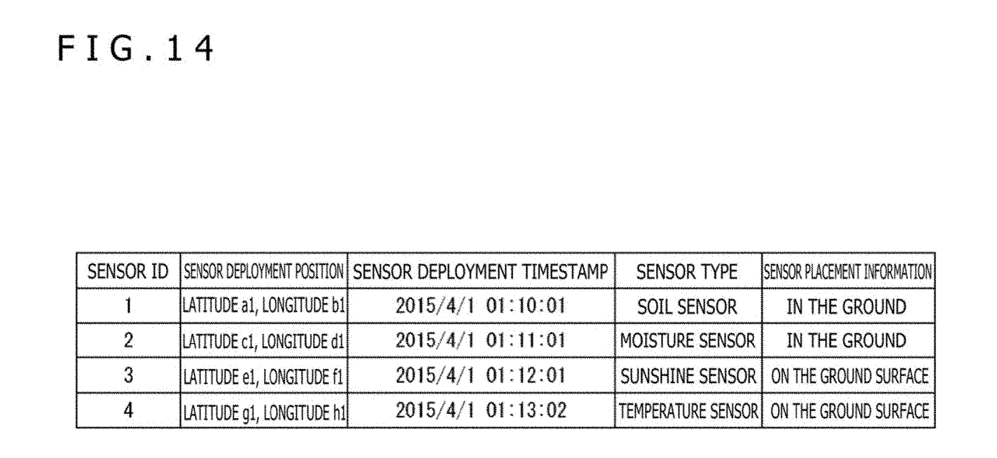

FIG. 14 depicts a typical sensor deployment log.

In the sensor deployment log, each sensor ID is associated with four items of information: a sensor deployment position, a sensor deployment timestamp, a sensor type, and sensor placement information.

The information item “sensor deployment information” is indicative of the position where the sensor 20 has been deployed. The “sensor deployment information” is basically the same as the information “work position” in the work instruction information.

The information item “sensor deployment timestamp” is indicative of the date and time at which the sensor 20 has been deployed.

The information item “sensor type” is the same as the information “work target” in the work instruction information. This is the information indicative of the type of the deployed sensor 20.

The information item “sensor placement information” is indicative of the status in which the sensor 20 is placed. There are two kinds of “sensor placement information”: “in the ground,” indicating that the sensor 20 is placed in the ground, and “on the ground surface,” indicating that the sensor 20 is placed on the ground surface.

The example in FIG. 14 is a sensor deployment log indicating four sensors 20 with sensor IDs 1 to 4. Every time a sensor 20 is deployed, the information about that sensor 20 is added to the sensor deployment log.

Returning to the flowchart of FIG. 13, in step S35, the display section 163 displays a screen indicative of work status under control of the control section 161.

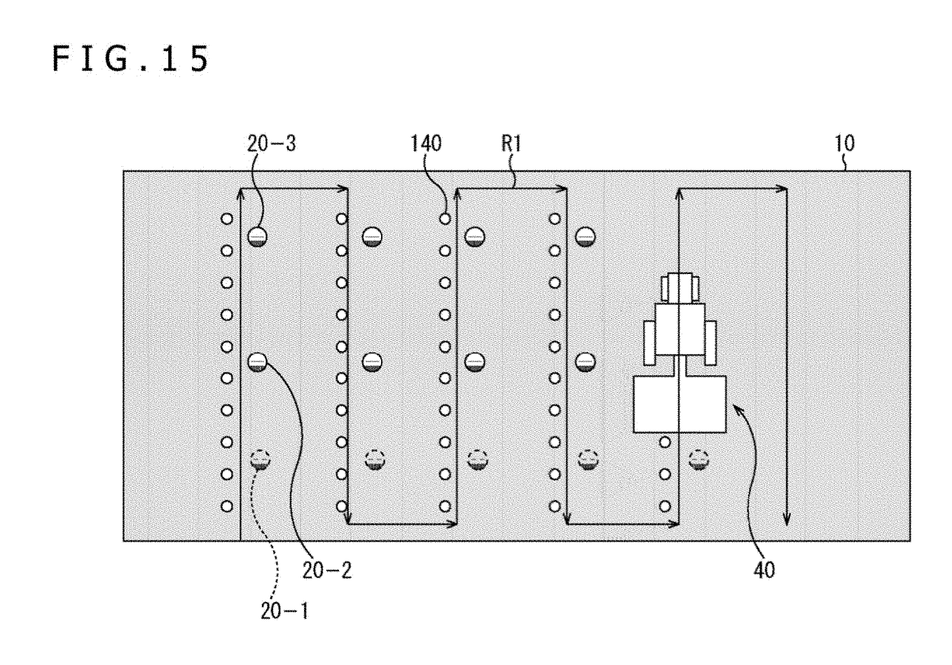

FIG. 15 depicts a typical screen display indicating work status.

FIG. 15 depicts how the sensors 20 and the crop 140 are deployed on the farm field 10 in accordance with the work instruction information. In FIG. 15, as in FIG. 12, the sensor 20-1 is depicted placed in the ground and the sensors 20-2 and 20-3 are depicted placed on the ground surface. Also in FIG. 15, arrows R1 are depicted to indicate the route to be traveled by the farm equipment system 40 according to the travel route information.

The screen indicating the work status has its display updated every time a sensor 20 is deployed.

Returning to the flowchart of FIG. 13, in step S36, the sensor deployment controlling section 191 determines whether or not all sensors 20 designated by the work instruction information have been deployed.

If it is determined that not all sensors 20 have been deployed yet, control is returned to step S31. The subsequent steps are then repeated.

If it is determined that all sensors 20 have been deployed, on the other hand, control is transferred to step S37.

In step S37, the control section 161 records to the storage section 165 the sensor deployment log generated by the log generating section 174.

In the above-described process, no matter how wide the farm field, the sensors are deployed at appropriate positions and in appropriate status based on the farm field information. This makes it possible to improve the efficiency of farm work.

Although not depicted in the flowchart of FIG. 13, the crop 140 is seeded in parallel with the deployment of the sensors 20 in accordance with the work instruction information of FIG. 11.

At this point, the log generating section 174 generates a seeding log based on the operation of the seeding mechanism 182 in parallel with the generation of the sensor deployment log.

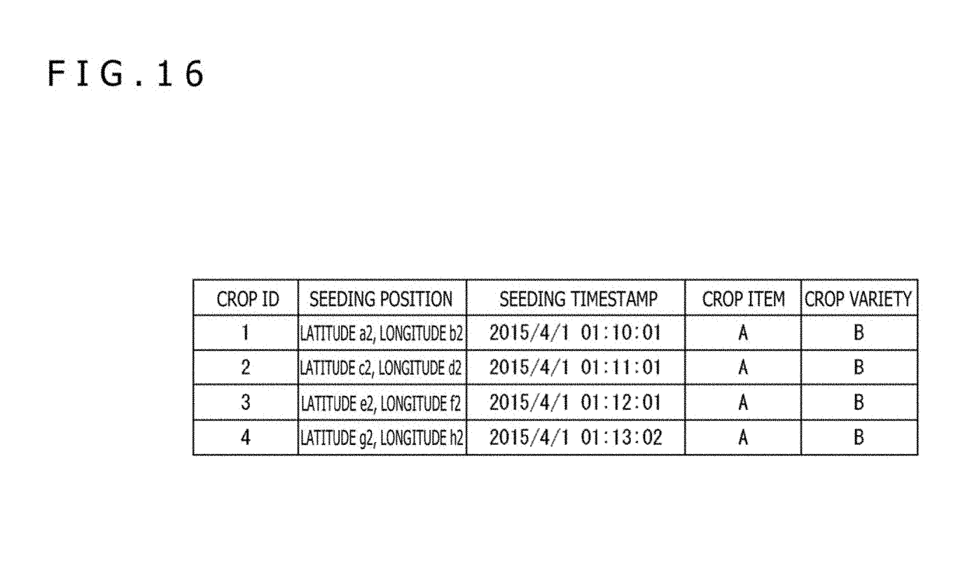

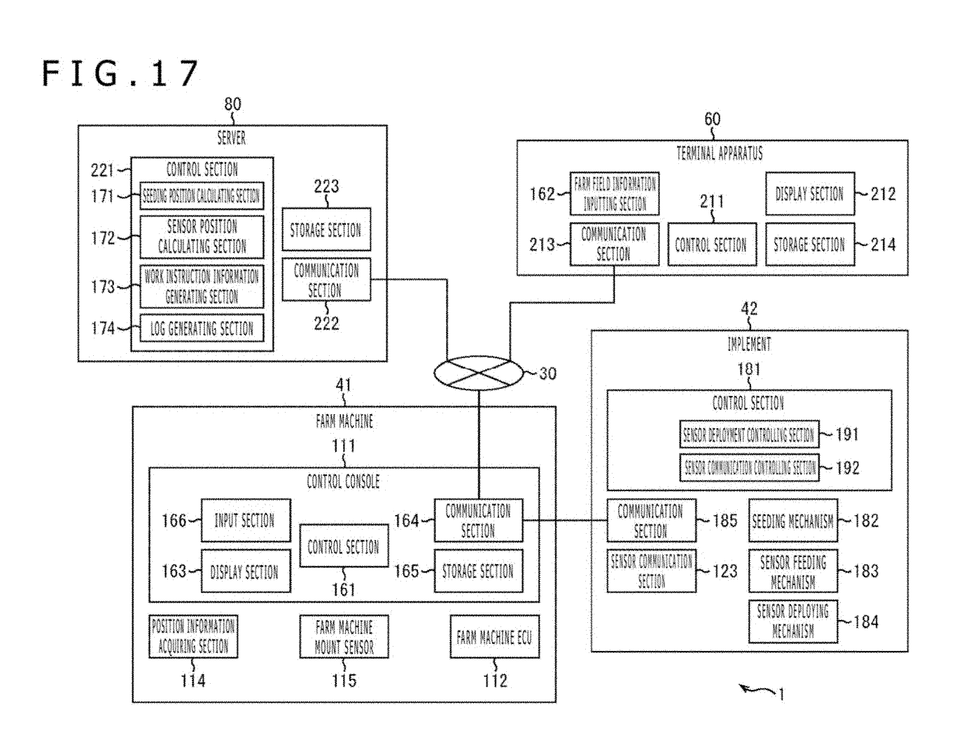

FIG. 16 depicts a typical seeding log.

In the seeding log, each crop ID identifying a crop is associated with four items of information: a seeding position, a seeding timestamp, a crop item, and a crop variety.

The information item “seeding position” is indicative of the position where the crop has been seeded. The “seeding position” is basically the same as the information “work position” in the work instruction information.

The information item “seeding timestamp” is indicative of the date and time at which seeding has been performed.

The information items “crop item” and “crop variety” are the same as the information “work target” in the work instruction information. These items constitute the information indicating the type and variety of the seeded crop.

The example in FIG. 16 depicts a seeding log related to four crops with four crop IDs 1 to 4. Every time a crop is seeded, the information about the crop is added to the seeding log. Note that the sensor deployment log depicted in FIG. 14 may be generated separately from the seeding log indicated in FIG. 16, or the two logs may be integrally generated as one log.

The foregoing paragraphs explained examples in which the farm equipment system 40 performs the work information generating process and the sensor deploying process. Alternatively, the farm field management system 1 may carry out the work information generating process and the sensor deploying process.

### (Typical Functional Configuration of the Farm Field Management System)

FIG. 17 depicts a typical functional configuration of the farm field management system 1. Note that the structures having the similar functions to those discussed above are given the same names and designated by the same reference signs, and these structures will not be discussed further.

In the farm field management system 1 of FIG. 17, the control console 111 of the farm machine 41 includes an input section 166 replacing the farm field information inputting section 162. The input section 166 receives input of predetermined information and feeds the input information to the control section 161.

The terminal apparatus 60 includes a control section 211, a display section 212, a communication section 213, a storage section 214, and the farm field information inputting section 162.

The control section 211 controls the components of the terminal apparatus 60. The display section 212 displays various screens under control of the control section 211. The communication section 213 communicates with the farm machine 41 and the server 80 via the network 30 under control of the control section 211. The storage section 214 stores diverse information and data under control of the control section 211.

Further, the farm field information inputting section 162 receives input of farm field information in accordance with the user's operations and feeds the input farm field information to the communication section 213. The communication section 213 transmits the farm field information to the server 80 via the network 30.

The server 80 includes a control section 221, a communication section 222, and a storage section 223.

The control section 221 controls the components of the server 80. The communication section 222 communicates with the farm machine 41 and the terminal apparatus 60 via the network 30 under control of the control section 221. The storage section 223 stores diverse information and data under control of the control section 221.

Also, the control section 221 includes the seeding position calculating section 171, sensor position calculating section 172, work instruction information generating section 173, and log generating section 174.

In the farm field management system 1 configured as described above, the terminal apparatus 60 and the server 80 perform the work instruction information generating process, and the farm equipment system 40 (farm machine 41 and implement 42) and the server 80 carry out the sensor deploying process.

Alternatively, the terminal apparatus 60 and the server 80 may be integrally configured as one unit.

### (Deployment of the Sensors by Real-Time Sensing)

Incidentally, the processes ranging from acquisition of the farm field information by real-time sensing to deployment of the sensors may be performed in real time by the farm equipment system 40.

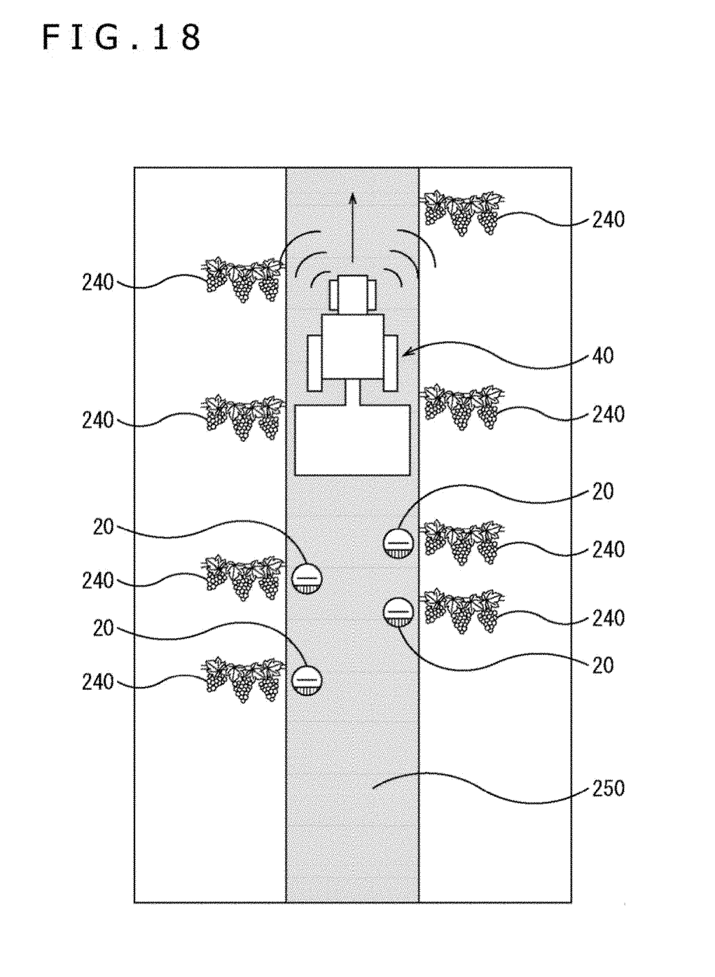

For example, as depicted in FIG. 18, the farm equipment system 40 acquires the farm field information while traveling on a road surface 250 constituting a strip road of the farm field where a crop 240 has been seeded. In this case, the farm field information may result from the recognition of images captured by the farm machine mount sensor 115 as well as data acquired by remote sensing.

The farm equipment system 40 generates the work instruction information and deploys the sensors in real time on the basis of the farm field information acquired during travel across the farm field.

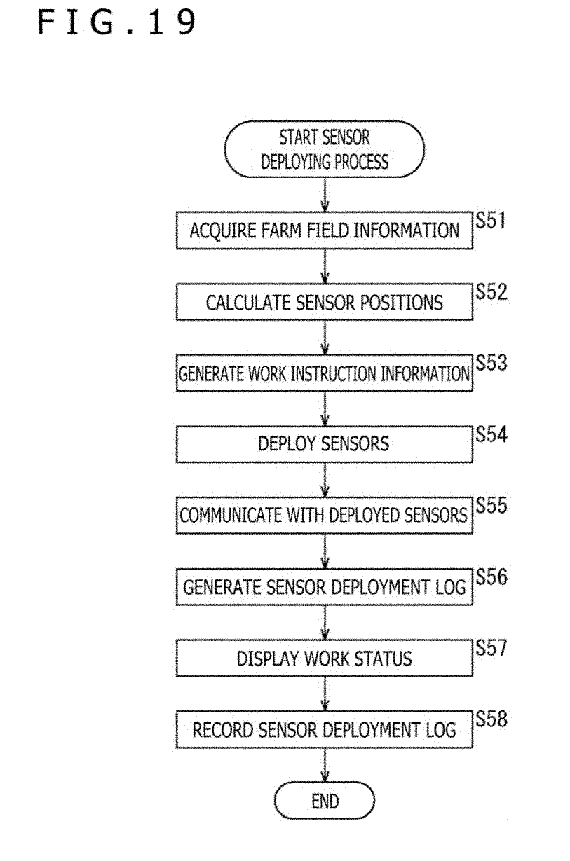

The sensor deploying process using real-time sensing is explained below with reference to the flowchart of FIG. 19. This process is performed by the farm equipment system 40 (farm machine 41 and implement 42) traveling across the farm field. Note that the process may be carried out by the farm equipment system 40 alone or by the farm field management system 1 as a whole.

In step S51, the farm machine mount sensor 115 acquires the farm field information.

For example, the farm machine mount sensor 115 acquires image data output from an incorporated image sensor detecting the light of frequencies in visible light and in near-infrared bands. The image data includes the crop 240 as a target subject and the road surface 250 on which the farm equipment system 40 travels, as well as position data about the topography of the farm field. The farm machine mount sensor 115 may incorporate two image sensors that output 3D image data by acquiring stereoscopic images. The farm machine mount sensor 115 may further incorporate a distance sensor such as an image sensor typically equipped with phase difference detection pixels so that depth (distance) data about the target subject corresponding to the image data may be output together with the image data. The farm machine mount sensor 115 may also incorporate a soil sensor to acquire data about the moisture and nutrients in the soil corresponding to the current position of the farm machine 40.

Note that, although the farm machine mount sensor 115 is described above as being mounted on the farm machine 41, the farm machine mount sensor 115 may alternatively be mounted on the implement 42 if the farm machine mount sensor 115 includes the soil sensor.

In step S52, the sensor position calculating section 172 calculates the sensor positions based on the farm field information acquired by the farm machine mount sensor 115.

For example, the sensor position calculating section 172 calculates the positional relation between the crop 240 on the one hand and the farm machine 41 and the implement 42 on the other hand by analyzing the image data output from the image sensor incorporated in the farm machine mount sensor 115. In this case, the sensor position calculating section 172 recognizes the crop 240 by performing image analysis of the image data. At the same time, the sensor position calculating section 172 calculates the positions of the crop 240 based on the above-mentioned 3D image data and depth data. The positional relation thus calculated permits calculation of an optimal deployment of the sensors for sensing the crop 240.

For example, as depicted in FIG. 18, each sensor is determined to be positioned on the strip road 250 and to have a distance not exceeding a predetermined threshold value from the crop 240. Alternatively, the sensor may be positioned on the strip road 250 in a manner closest to the crop 240.

As another alternative, the sensor positions may be determined on the basis of soil moisture and nutrient data acquired by the soil sensor incorporated in the farm machine mount sensor 115. For example, the sensor position may be a position where the amount of moisture and that of nutrients are close to their averages within a predetermined range, or a position where the amount of moisture and that of nutrients are larger or smaller than their averages by a predetermined amount each.

In the sensor deploying process using real-time sensing, the sensor position is determined by adding the offset of the mount position of the farm machine mount sensor 115 and the offset of the mount position of the implement mechanism 122 in the implement 42 or the offset of the sensor position to the current position acquired by the position information acquiring section 114 of the farm machine 41.

Note that, in order to secure the time to perform the process of calculating the above-mentioned sensor position, it is preferred that the farm machine mount sensor 115 be disposed in front (in the advancing direction) of either the rear wheels or the cab seat in which the user operating the farm machine 41 sits and that the implement 42 be connected behind the farm machine 41 (in a direction opposite to the advancing direction).

In step S53, the work instruction information generating section 173 generates the work instruction information based on the calculated sensor positions. The work instruction information does not include information related to seeding.

In step S54, the sensor deployment controlling section 191 controls the sensor deploying mechanism 184 to deploy the sensors 20 in accordance with the work instruction information.

In step S55, the sensor communication controlling section 192 controls the sensor communication section 123 to communicate with the deployed sensors 20. In so doing, the sensor communication controlling section 192 acquires the sensor IDs of the sensors 20 and sends the acquired sensor IDs to the log generating section 174.

In step S56, the log generating section 174 generates the sensor deployment log based on the operation of the sensor deploying mechanism 184 and on the sensor IDs from the sensor communication controlling section 192.

In step S57, the display section 163 displays (updates) the screen indicative of work status under control of the control section 161.

In step S58, the control section 161 (control section 221) records to the storage section 165 (storage section 223) the sensor deployment log generated by the log generating section 174.

The above-described process is carried out every time farm field information is acquired.

Alternatively, the seeding log may be acquired when seeding is performed using real-time sensing in a manner similar to the above-described process.

In the above-described process, no matter how wide the farm field, the sensors are deployed in real time at appropriate positions and in appropriate status based on the farm field information. This makes it possible to further improve the efficiency of farm work.

The foregoing paragraphs describe examples of how to deploy the sensors on the farm field. Explained below is an example of how to utilize sensor data from the sensors deployed on the farm field.

### <3. Utilization of Sensor Data>

The farm field management system 1 performs such work as watering and fertilizing based on sensor data from the sensors deployed on the farm field.

### (Typical Functional Configuration of the Farm Field Management System)

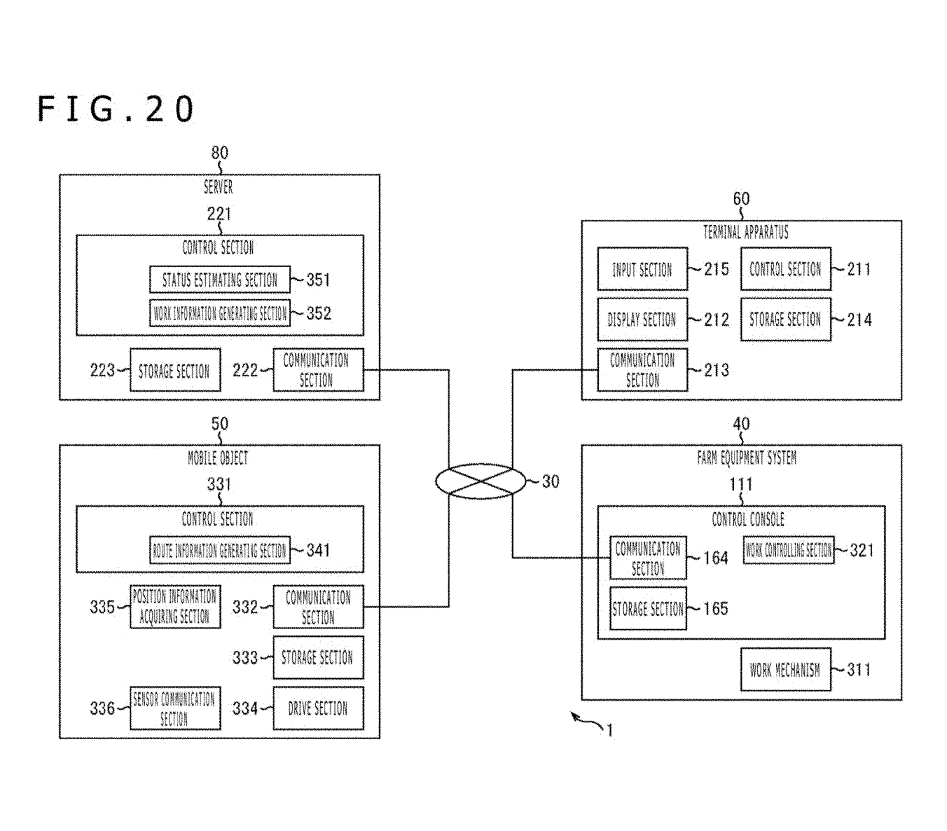

FIG. 20 depicts a typical functional configuration of the farm field management system that performs work on the basis of the sensor data. Note that the structures having the similar functions to those discussed above are given the same names and designated by the same reference signs, and these structures will not be discussed further.

In the farm field management system 1 of FIG. 20, the farm equipment system 40 includes the control console 111, communication section 164, storage section 165, and a work mechanism 311.

The work mechanism 311 has the function of performing such work as watering and fertilizing on the farm field.

Further, the control console 111 includes a work controlling section 321. The work controlling section 321 controls the work mechanism 311 to carry out work. Note that the work in this case typically involves watering and fertilizing on the farm field. That is, the work controlling section 321 controls the positions and levels of watering and fertilizing on the farm field.

The mobile object 50 includes a control section 331, a communication section 332, a storage section 333, a drive section 334, a position information acquiring section 335, and a sensor communication section 336.

The control section 331 controls the components of the mobile object 50. The communication section 332 communicates with the terminal apparatus 60 and the server 80 via the network 30 under control of the control section 331. The storage section 333 stores diverse information and data under control of the control section 331. The drive section 334 includes an engine or a motor, for example. The drive section 334 causes the mobile object 50 to travel under control of the control section 331.

The position information acquiring section 335 acquires (measures) the current position of the mobile object 50 with an error of a few centimeters. The position information acquiring section 335 is configured as an RTK-GPS receiver, for example, like the above-mentioned position information acquiring section 114.

The sensor communication section 336 acquires the sensor data from the sensors 20 deployed on the farm field 10 by communicating with the sensors 20.

The control section 331 also includes a route information generating section 341. The route information generating section 341 generates route information indicative of the route traveled by the mobile object 50 across the farm field.

The terminal apparatus 60 includes an input section 215 replacing the farm field information inputting section 162 depicted in FIG. 17. The input section 215 receives input of predetermined information and feeds the input information to the communication section 213. The communication section 213 transmits the information to the server 80 via the network 30.

The control section 221 of the server 80 includes a status estimating section 351 and a work information generating section 352.

The status estimating section 351 estimates the status of the sensors 20 on the basis of the sensor data acquired by the sensor communication section 336 of the mobile object 50.

The work information generating section 352 generates work information indicative of the details of work performed by the work mechanism 311 on the farm field on the basis of the status of the sensors 20 estimated by the status estimating section 351.

Note that the storage section 223 of the server 80 stores the sensor deployment log and the seeding log generated during the sensor deploying process.

### (Sensor Data Acquiring Process)

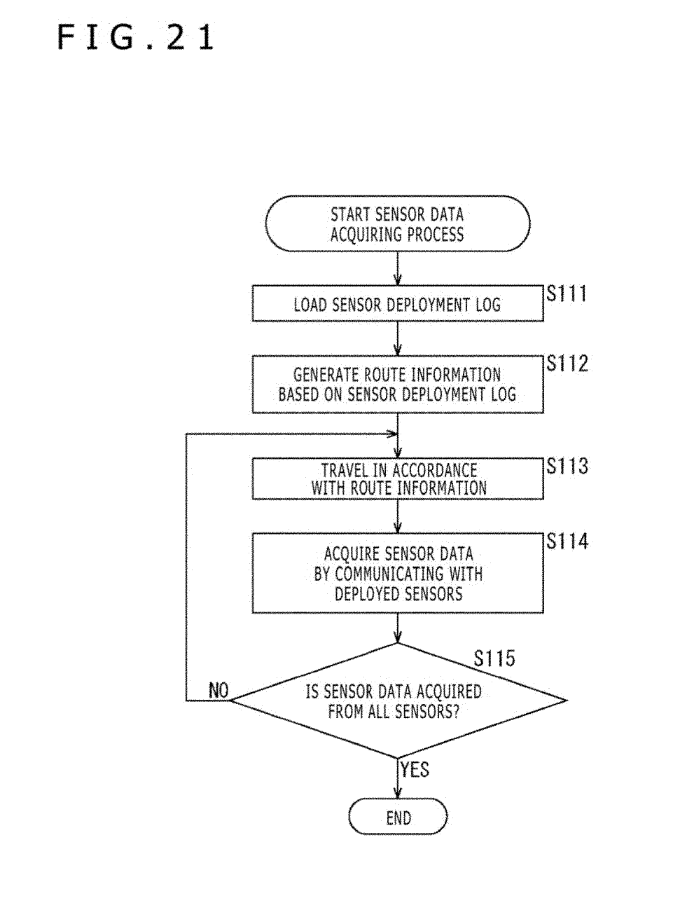

A sensor data acquiring process is explained below with reference to the flowchart of FIG. 21. This process is started by the user operating the terminal apparatus 60, for example.

In step S111, the control section 331 of the mobile object 50 loads via the network 30 the sensor deployment log stored in the storage section 223 of the server 80. At this point, the seeding log is also loaded along with the sensor deployment log.

In step S112, the route information generating section 341 generates route information based on the loaded sensor deployment log.

If the travel of the mobile object 50 is designated at this point by the user operating the terminal apparatus 60, for example, the drive section 334 in step S113 causes the mobile object 50 to travel in accordance with the route information under control of the control section 331.

When the current position acquired by the position information acquiring section 335 of the mobile object 50 reaches the position indicated by a given sensor deployment position in the sensor deployment log, the sensor communication section 336 in step S114 communicates with the corresponding sensor 20 deployed in the farm field so as to acquire the sensor data from the sensor 20.

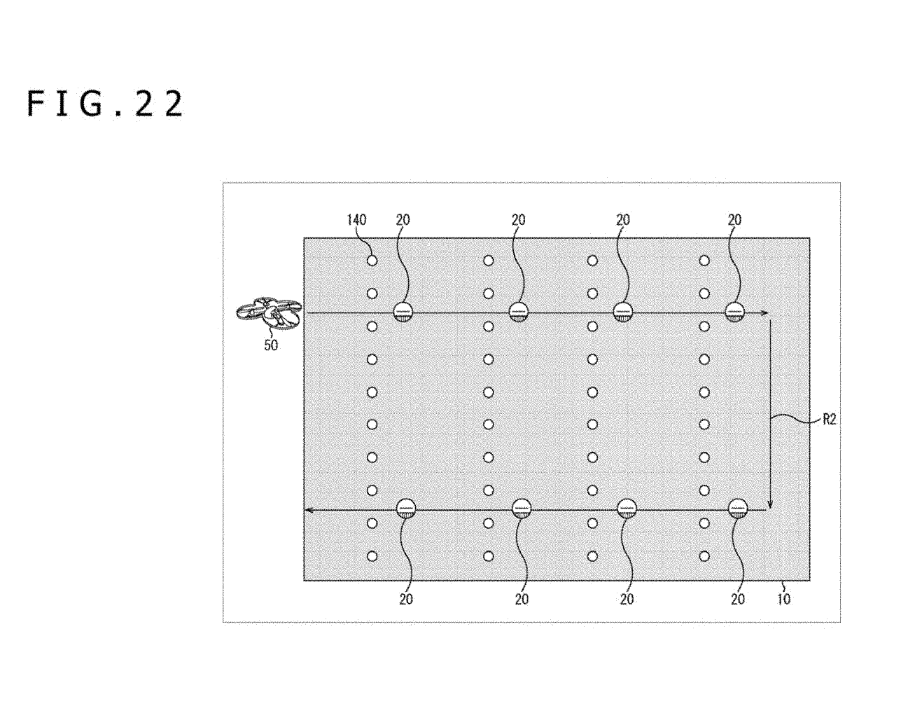

FIG. 22 is a schematic diagram explaining a travel route at the time of acquiring sensor data.

The example in FIG. 22 depicts arrows R2 indicative of the travel route established in a manner connecting eight sensors 20 with one another deployed on the farm field 10. The mobile object 50 travels across the farm field along the travel route indicated by the arrows R2. Upon reaching a position where a sensor 20 is deployed, the mobile object 50 communicates with that sensor 20.

Here, if the mobile object 50 is a flying object such as a drone, the drive section 334 under control of the control section 331 adjusts the flight altitude of the mobile object 50 in accordance with the sensor placement information in the sensor deployment log (i.e., whether the sensor 20 is in the ground or on the ground surface). Also under control of the control section 331, the sensor communication section 336 adjusts the radio field strength used for communication with the sensor 20 in accordance with the sensor placement information.

Such adjustments enable the sensor communication section 336 to reliably acquire the sensor data even when the radio waves from the sensors 20 placed in the ground are thereby attenuated considerably.

Returning to the flowchart of FIG. 21, the control section 331 in step S115 determines whether or not the sensor data is acquired from all sensors 20 on the basis of the loaded sensor deployment log.

If it is determined that the sensor data from all sensors 20 has yet to be acquired, control is returned to step S113. The subsequent steps are then repeated.

If it is determined that the sensor data is acquired from all sensors 20, on the other hand, the process is terminated. The acquired sensor data is stored into the storage section 223 of the server 80 via the network 30 as a sensor data log associated with the information in the sensor deployment log.

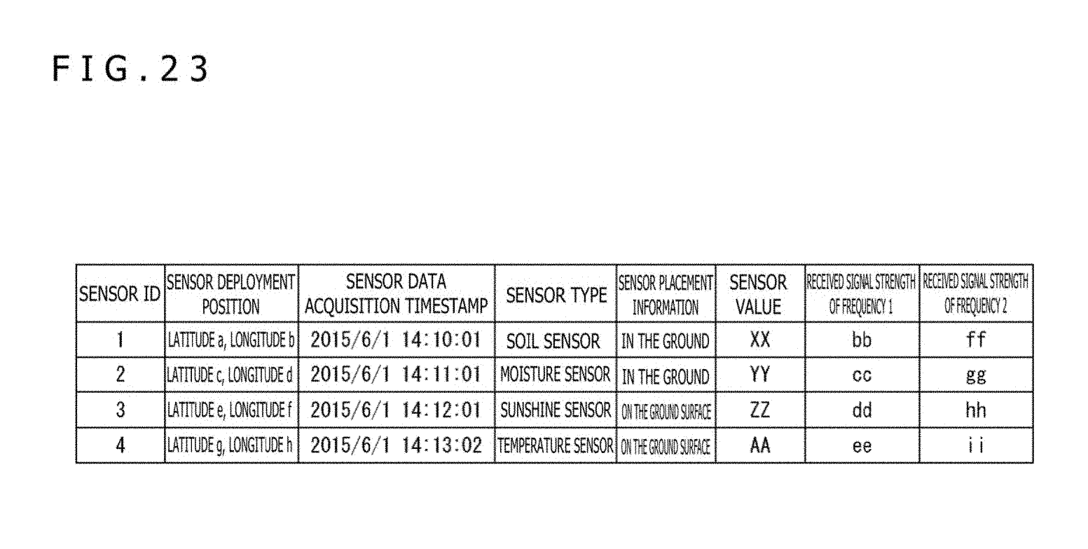

FIG. 23 depicts a typical sensor data log.

In the sensor data log, each sensor ID is associated with seven items of information: a sensor deployment position, a sensor data acquisition timestamp, a sensor type, sensor placement information, a sensor value, received signal strength of frequency 1, and received signal strength of frequency 2.

Of these information items, “sensor deployment position,” “sensor type,” and “sensor placement information” are the same as their counterparts in the sensor deployment log. The “sensor deployment position” in the sensor deployment log and in the sensor data log may be updated (generated) on the basis of the positions acquired by the position information acquiring section 335 at the time of acquiring the sensor data.

The information item “sensor data acquisition timestamp” is indicative of the date and time at which the sensor data has been acquired from each sensor 20.

The information item “sensor value” is a piece of information included in the acquired sensor data. The “sensor value” is information representing a value corresponding to the power generated by each sensor 20.

The information item “received signal strength of frequency 1” is indicative of the strength of radio waves received from a given sensor 20 when the sensor communication section 336 communicates with that sensor 20 using radio waves of a first frequency.

The information item “received signal strength of frequency 2” is indicative of the strength of radio waves received from a given sensor 20 when the sensor communication section 336 communicates with that sensor 20 using radio waves of a second frequency different from the first frequency.

The example in FIG. 23 depicts a sensor data log regarding four sensors 20 having sensor IDs 1 to 4, as in the sensor deployment log of FIG. 14.

### (Work Information Generating Process)

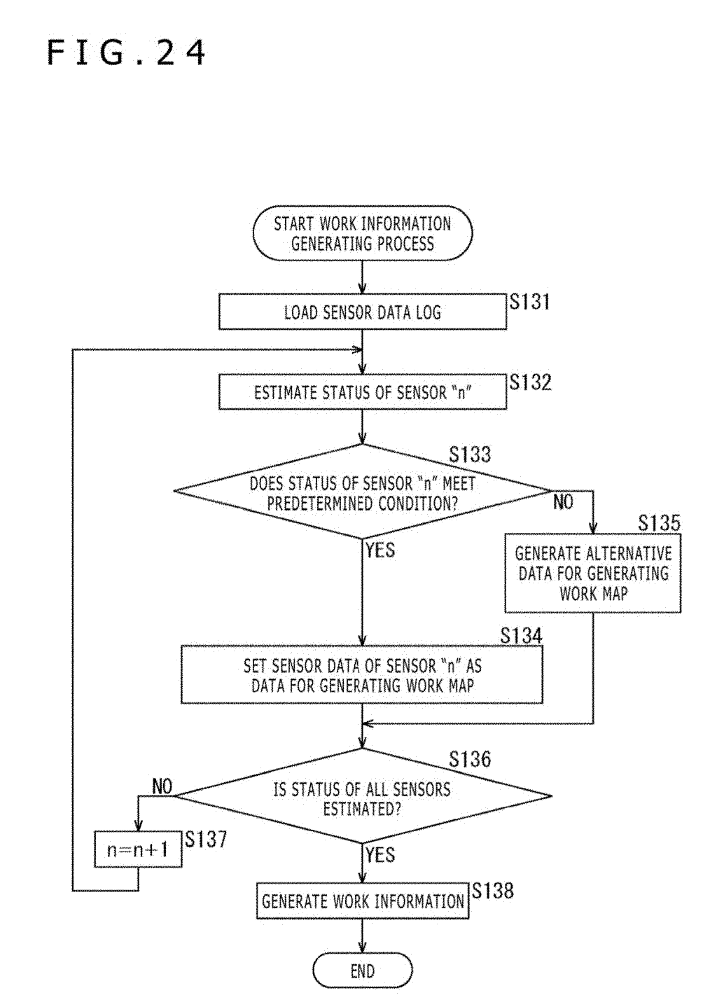

A work information generating process is explained below with reference to the flowchart of FIG. 24. This process is also started by the user operating the terminal apparatus 60, for example.

In step S131, the status estimating section 351 of the server 80 loads the sensor data log from the storage section 223.

In step S132, the status estimating section 351 estimates the status of a sensor “n” having a sensor ID of “n” (n=1 initially) from among multiple sensors in accordance with the sensor data log.

Specifically, the status estimating section 351 estimates the status of the sensor 20 of interest using “received signal strength of frequency 1” and “received signal strength of frequency 2” associated with the corresponding sensor ID in the sensor data log on the basis of the attenuation of radio waves at each frequency from the sensor 20.

For example, the attenuation of radio waves at each frequency from the sensor 20 is used to estimate whether the sensor is in the ground or on the ground surface. Alternatively, the attenuation of radio waves at each frequency from the sensor may be used to estimate whether the sensor is in a high-moisture or a low-moisture environment. As another alternative, the attenuation of radio waves at each frequency from the sensor may be used to estimate whether or not the surface of the sensor is dirty.

In step S133, the work information generating section 352 determines whether or not the status of the sensor “n” meets a predetermined condition. The predetermined condition in this case is that the status of the sensor “n” is not to be significantly different from the status of sensors deployed in the surroundings, for example. The status of “not being significantly different from the status of sensors deployed in the surroundings” typically signifies that the difference between the attenuation of radio waves at each frequency from the communicating sensor “n” and a predetermined reference attenuation does not exceed a predetermined threshold value. Alternatively, the work information generating section 352 may determine that the status of the sensor “n” meets the predetermined condition upon verifying that the value or data representing the status of the sensor “n” falls within a predetermined range or within predetermined status limits compared with a predetermined reference.

If it is determined that the status of the sensor “n” meets the predetermined condition, control is transferred to step S134.

In step S134, the work information generating section 352 sets the sensor data about the sensor “n” as data for generating a work map. The work map in this case is a map indicating the details of work in various areas of the farm field 10.

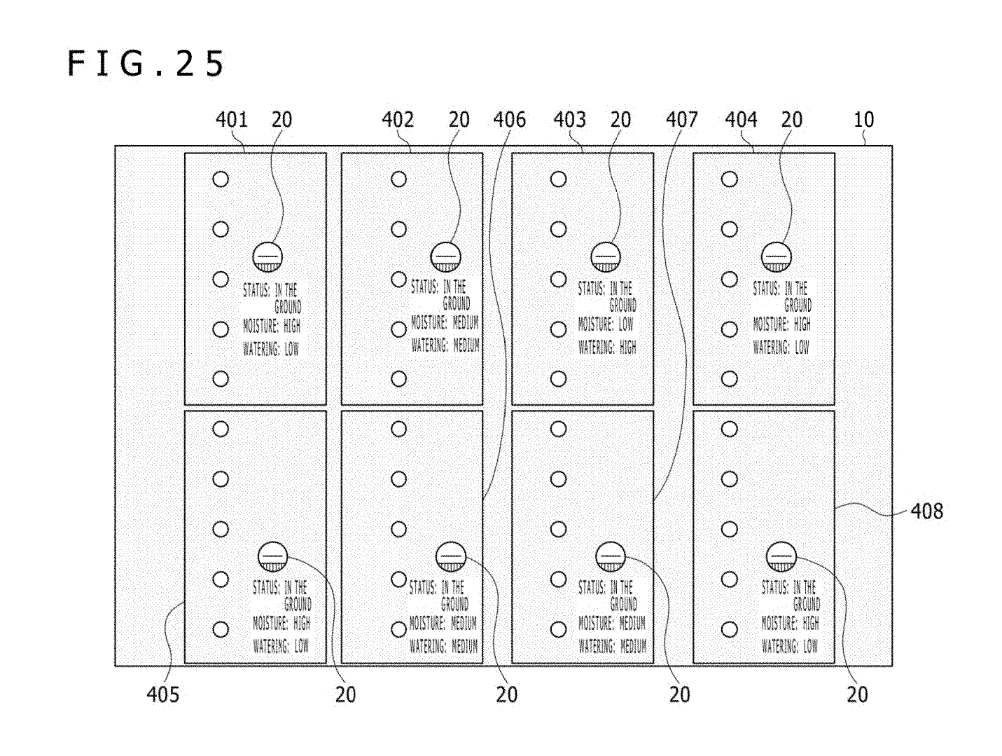

FIG. 25 is a schematic diagram explaining a work map.

In FIG. 25, the farm field 10 is divided into eight areas 401 to 408 by eight sensors 20 being deployed. Each area is set with the status (surrounding environment) of the sensor 20 deployed in the area estimated on the basis of the sensor data from the sensor 20 and with the detail of work corresponding to the estimated status.

For example, the area 401 is set with the status of the sensor 20 being in the ground at a high level of moisture and with the detail of work involving obtaining a low level of watering. The area 402 is set with the status of the sensor 20 being in the ground at a medium level of moisture and with the detail of work involving obtaining a medium level of watering. The area 403 is set with the status of the sensor 20 being in the ground at a low level of moisture and with the detail of work involving obtaining a high level of watering.

In the example of FIG. 25, as described above, the work map has the settings of the status of the sensor 20, the level of moisture, and the level of watering reflecting the moisture level for each area on the farm field 10.

Note that, in the example of FIG. 25, there is not much difference between the status of each sensor 20 (each area) and the status of the sensors 20 deployed in the surroundings (surrounding areas). That is, each sensor 20 is in the appropriate environment, so that the above-mentioned predetermined condition is met.

Meanwhile, if it is determined in step S133 that the status of the sensor “n” fails to meet the predetermined condition, control is transferred to step S135.

In step S135, the work information generating section 352 does not set the sensor data about the sensor “n” as data for generating the work map. Instead, the work information generating section 352 generates alternative data for work map generation.

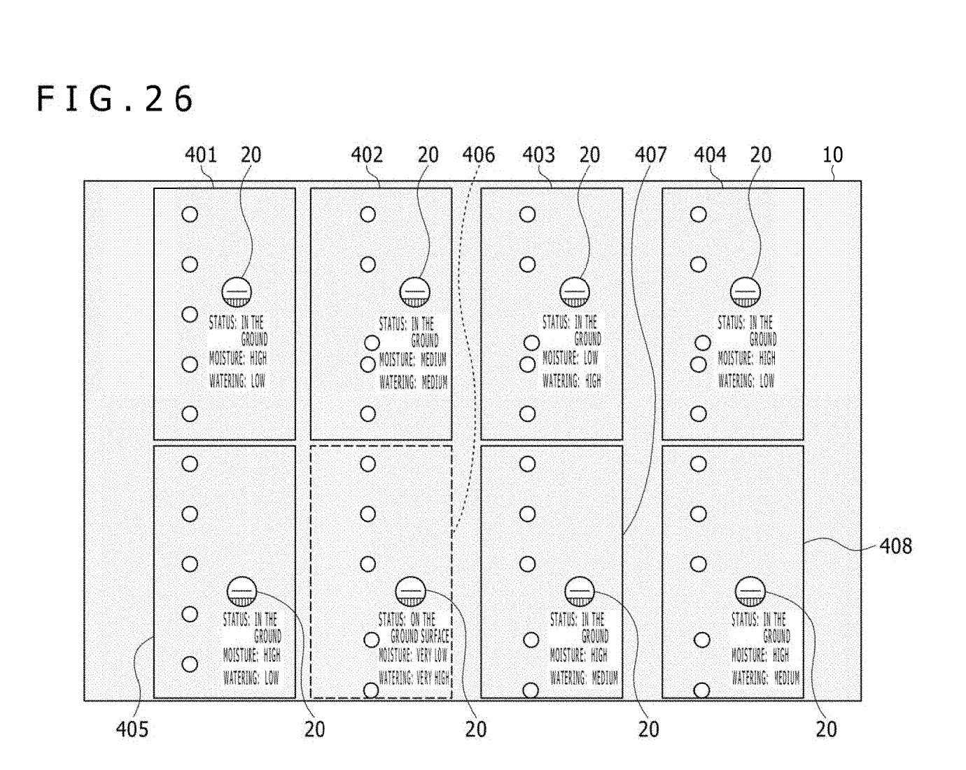

For example, as in the work map depicted in FIG. 26, the area 406 is set with the status of the sensor 20 being on the ground surface at a very low level of moisture and with the detail of work involving obtaining a very high level of watering.

In the example of FIG. 26, there is considerable difference between the status of the sensor 20 deployed in the area 406 and the status of the sensors 20 deployed in the surroundings. That is, the sensor 20 deployed in the area 406 is not in the appropriate environment, so that the above-mentioned predetermined condition is not met.

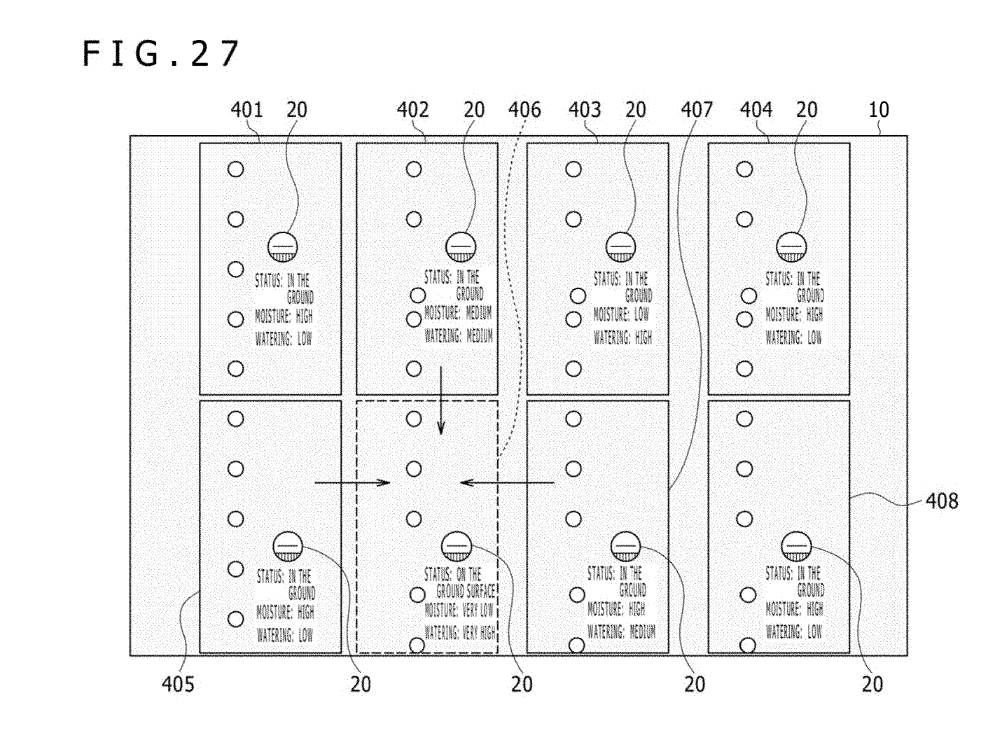

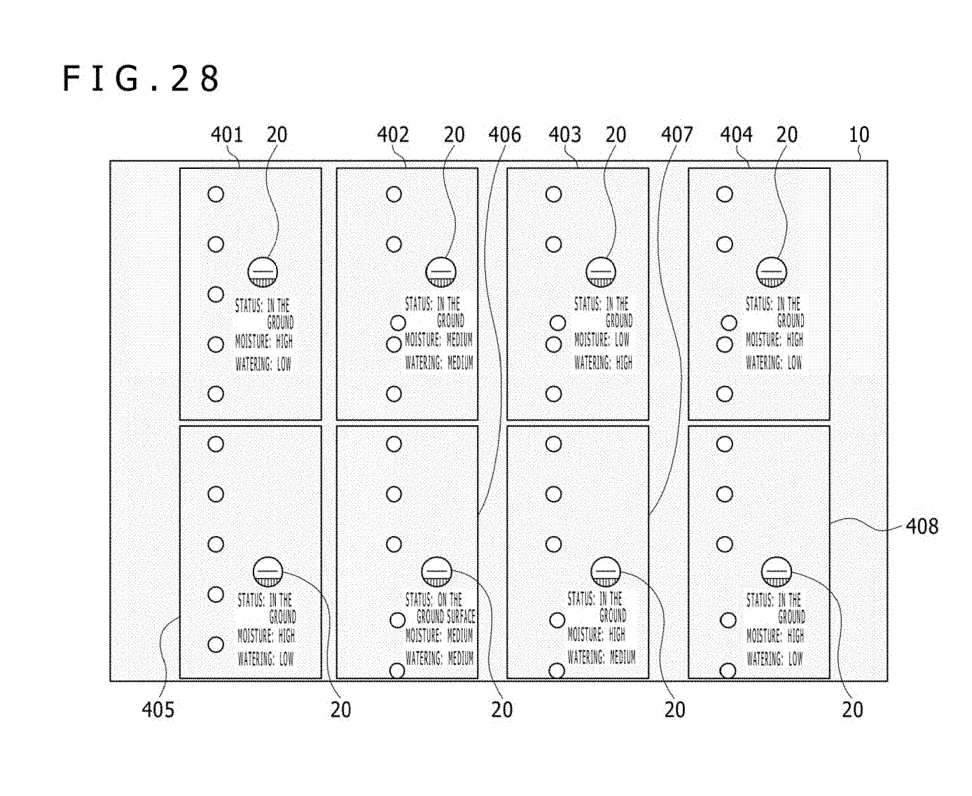

In such a case, as depicted in FIG. 27, the area 406 is given status representative of an average of the status settings of the sensors 20 deployed in the areas 402, 405 and 407 surrounding the area 406. As a result, as depicted in FIG. 28, the area 406 is set with alternative data representing the status of the sensor 20 being on the ground surface at a medium level of moisture and with the detail of work involving obtaining a medium level of watering.

After step S134 or S135, control is transferred to step S136.

In step S136, the status estimating section 351 determines whether or not the status is estimated for all sensors in the sensor data log.

If it is determined that the status has yet to be estimated for all sensors, control is transferred to step S137. In step S137, the status estimating section 351 increments the sensor ID value “n” by 1. Control is then returned to step S132 and the subsequent steps are repeated.

If it is determined that the status is estimated for all sensors, on the other hand, control is transferred to step S138.

In step S138, the work information generating section 352 generates work information based on the sensor data log, on the work map data, on the information about the farm field 10, and on the information about the farm equipment system 40.

This is how the work information is generated.

Note that it is explained above that the sensor status is estimated on the basis of the attenuation of radio waves at each frequency. Alternatively, each sensor may be equipped with a sensing section sensing the status of the own sensor and transmit information representing the sensed sensor status to the server 80. In this case, the work information generating section 352 of the server 80 determines whether or not the sensor status meets the predetermined condition on the basis of the sensor status information transmitted from the sensor.

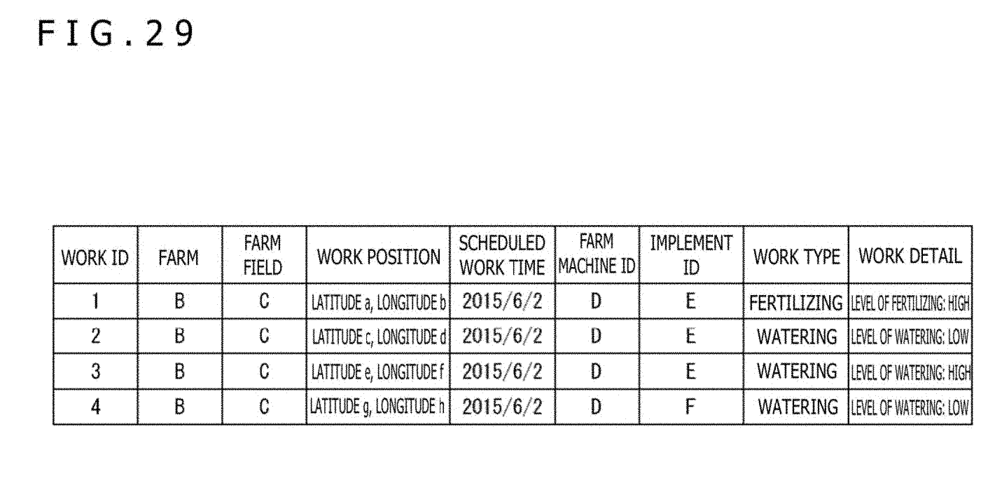

FIG. 29 depicts typical work information.

In the work information, each work ID is associated with eight items of information: a farm, a farm field, a work position, a scheduled work time, a farm machine ID, an implement ID, a work type, and a work detail.

The information item “farm” is indicative of the farm (or its owner) where the farm field to be worked on is located.

The information item “farm field” is indicative of the farm field where work is to be performed.

The information item “work position” is indicative of the position (in latitude and longitude) where the work identified by the corresponding work ID is to be performed.

The information item “scheduled work time” is indicative of the date and time at which the work identified by the corresponding work ID is to be performed.

The information item “farm machine ID” is information identifying the farm machine 41 coupled to the implement 42 performing the work identified by the corresponding work ID.

The information item “implement ID” is information identifying the work mechanism of the implement 42 performing the work identified by the corresponding work ID. For example, the “implement ID” is information identifying a fertilizing mechanism or a watering mechanism.

The information item “work type” is indicative of the type of work identified by the corresponding work ID. There are typically two “work types”: “fertilizing,” to be performed by the fertilizing mechanism, and “watering,” to be carried out by the watering mechanism.

The information item “work detail” is indicative of the detail of work identified by the corresponding work ID. If the “work type” is “fertilizing,” the “work detail” is information indicative of the level of fertilizing to be performed. If the “work type” is “watering,” the “work detail” is information indicative of the level of watering to be carried out.

Further, on the basis of the “work position” in the work information, travel route information indicative of the route to be traveled by the farm equipment system 40 may be generated and included into the work information.

Note that the work information thus generated is stored via the network 30 into the storage section 165 of the farm equipment system 40 that performs work.

It is explained above that the status of each sensor 20 is estimated by the server 80. Alternatively, the control section 331 of the mobile object 50 may include the status estimating section 351 so that the mobile object 50, while traveling, may estimate the status of each sensor 20 in real time.

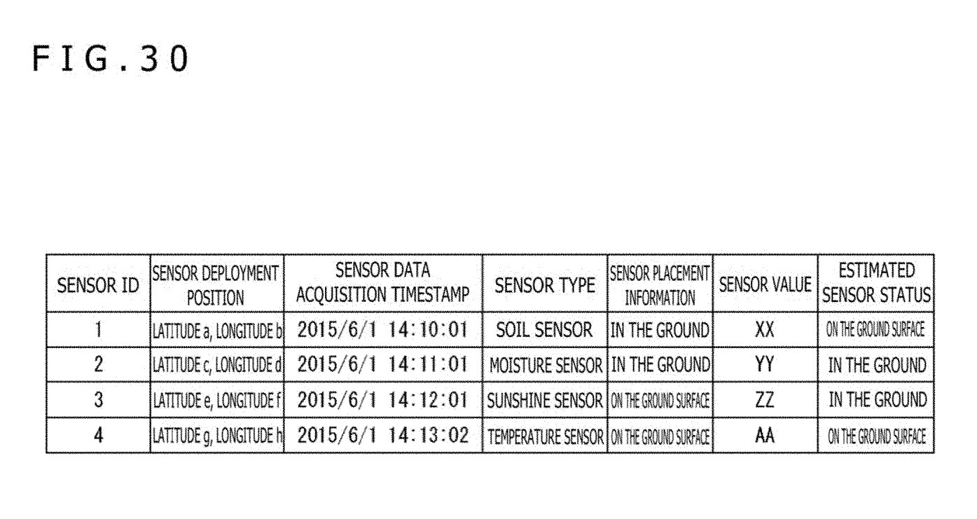

In that case, a sensor data log such as one depicted in FIG. 30 is obtained.

In the sensor data log of FIG. 30, the information “estimated sensor status” is set to replace the “received signal strength of frequency 1” and “received signal strength of frequency 2” in the sensor data log of FIG. 23.

The information “estimated sensor status” is indicative of the status of each sensor 20 estimated by the mobile object 50. In the example of FIG. 30, the information indicating that the sensor is on the ground surface or in the ground is set as the status of each sensor 20.

### (Work Process)

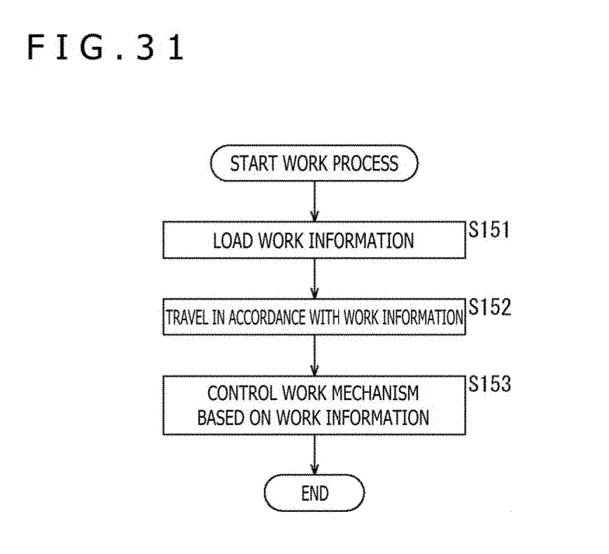

A work process is explained below with reference to the flowchart of FIG. 31.

In step S151, the control console 111 of the farm equipment system 40 loads the work information from the storage section 165. At this point, the data related to the farm field 10 is also loaded along with the work information.

If the travel of the farm equipment system 40 is designated at this point by the user operating the control console 111, for example, the farm equipment system 40 in step S152 travels across the farm field 10 in accordance with the loaded work information (travel route information). When traveling, the farm equipment system 40 may be steered by the user watching a screen displayed to indicate the travel route based on the travel route information. Alternatively, the farm equipment system 40 when traveling may be steered with cruise control in accordance with the travel route information.

When the current position acquired by the position information acquiring section 114 (FIG. 6) of the farm equipment system 40 reaches the positions indicated by the work positions in the work information, the work controlling section 321 in step S153 controls the work mechanism 311 in accordance with the work information. In so doing, the work controlling section 321 causes the work mechanism 311 to perform on the farm field 10 the work designated by the corresponding work type and work detail in the work information.

In the above-described process, work is performed appropriately on the basis of the sensor status. This contributes to enhancing the efficiency of farm work.

(Utilization of Sensor Data from Real-Time Sensing)

The processes ranging from acquisition of sensor data by real-time sensing to the work on the farm field 10 may be performed by the farm equipment system 40 in real time.

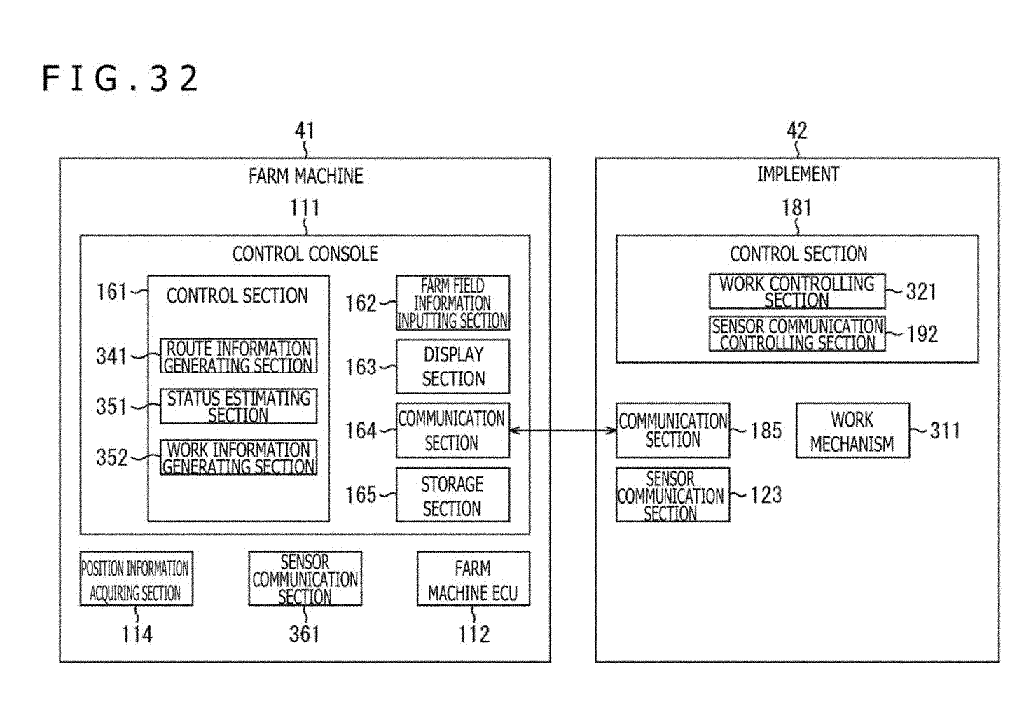

FIG. 32 depicts a typical functional configuration of the farm equipment system 40 carrying out in real time the processes ranging from acquisition of sensor data to the work on the farm field 10. Note that the structures having the similar functions to those discussed above are given the same names and designated by the same reference signs, and these structures will not be discussed further.

In the farm machine 41 of FIG. 32, the control console 111 includes the route information generating section 341, status estimating section 351, and work information generating section 352.

Further, the farm machine 41 includes a sensor communication section 361 replacing the farm machine mount sensor 115 (FIG. 9). The sensor communication section 361 communicates with the sensors 20 deployed on the farm field 10 in order to acquire the sensor data therefrom.

The implement 42 includes the work mechanism 311 as an implement mechanism.

Further, the control section 181 of the implement 42 includes the work controlling section 321 replacing the sensor deployment controlling section 191 (FIG. 9).

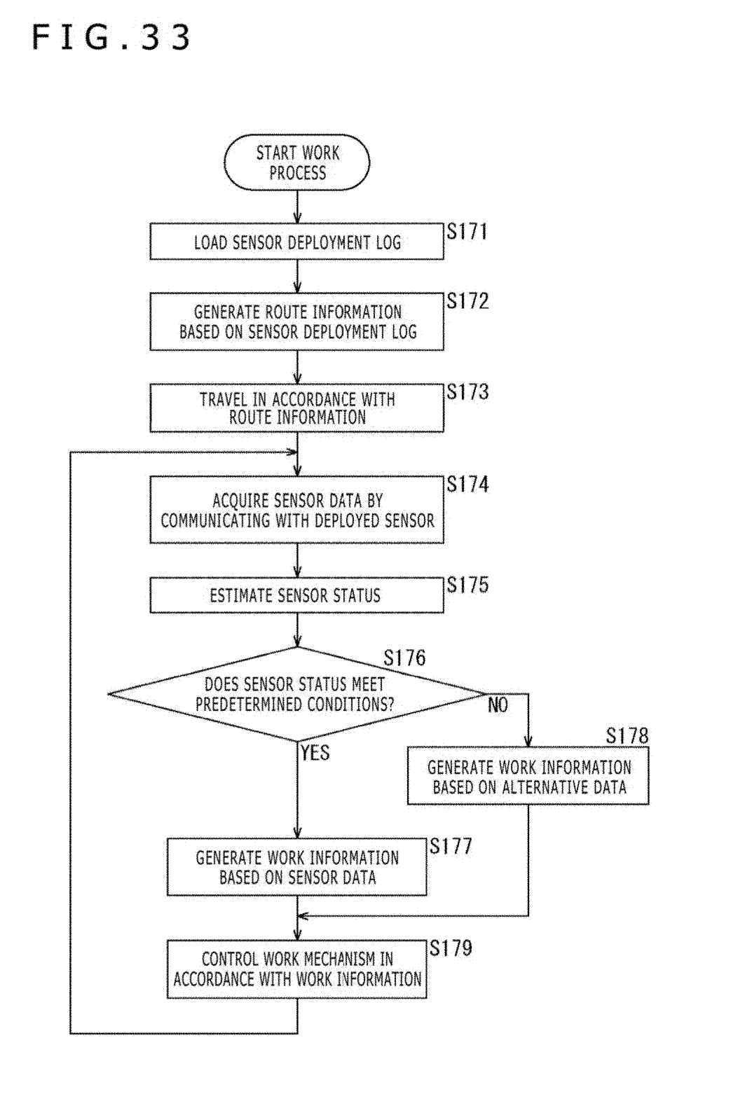

A work process based on real-time sensing is explained below with reference to the flowchart of FIG. 33. This process is performed by the farm equipment system 40 (farm machine 41 and implement 42) traveling across the farm field 10. The process may be carried out by the farm equipment system 40 alone or by the farm field management system 1 as a whole.

In step S171, the control console 111 of the farm machine 41 loads the sensor deployment log from the storage section 223 of the server 80 via the network 30. At this point, the seeding log is also loaded along with the sensor deployment log.

In step S172, the route information generating section 341 generates route information based on the loaded sensor deployment log. Alternatively, the route information generating section 341 may generate the route information using the seeding log in addition to the sensor deployment log.

When the travel of the farm equipment system 40 is designated at this point by the user operating the control console 111, for example, the farm equipment system 40 in step S173 travels in accordance with the route information.

When the current position acquired by the position information acquiring section 114 of the farm equipment system 40 reaches the position indicated by a given sensor deployment position in the sensor deployment log, the sensor communication section 361 in step S174 communicates with the corresponding sensor 20 deployed on the farm field 10 so as to acquire the sensor data from that sensor 20.

In step S175, the status estimating section 351 estimates the status of the sensor 20 on the basis of the sensor data acquired from that sensor 20.

In step S176, the work information generating section 352 determines whether or not the status of the sensor 20 meets predetermined conditions.

If it is determined that the status of the sensor 20 meets the predetermined conditions, control is transferred to step 176.

In step S176, the work information generating section 352 generates work information about the sensor 20 on the basis of the acquired sensor data.

If it is determined in step S176 that the status of the sensor 20 fails to meet the predetermined conditions, on the other hand, control is transferred to step S178.

In step S178, the work information generating section 352 generates the work information about the sensor 20 on the basis of the above-mentioned alternative data instead of the acquired sensor data.

After step S177 or S178, control is transferred to step S179.

In step S179, the work controlling section 321 controls the work mechanism 311 in accordance with the work information. In so doing, the work controlling section 321 causes the work mechanism 311 to perform on the farm field 20 the work designated by the work type and work detail in the work information.

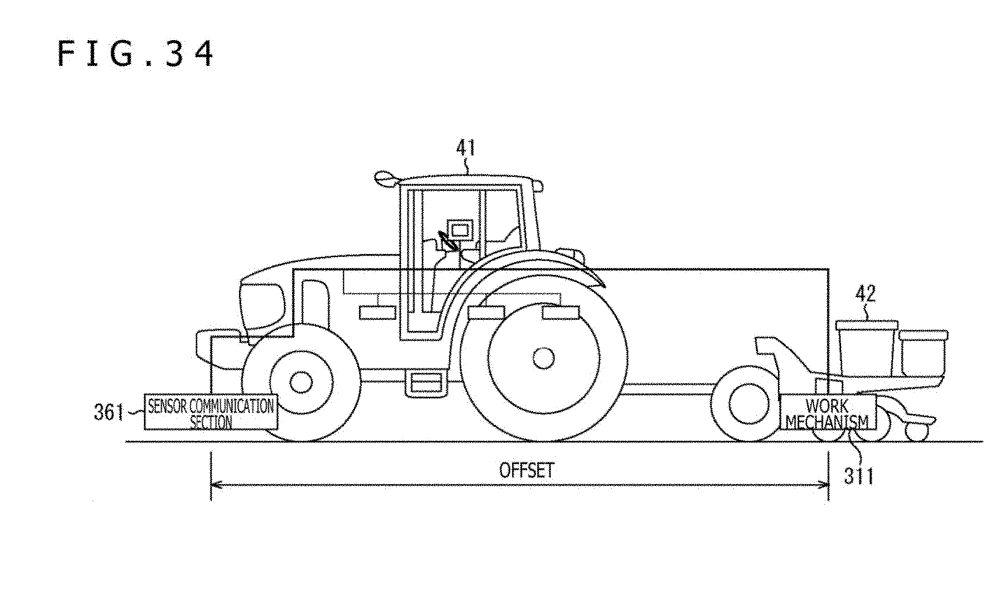

Note that, as depicted in FIG. 34, the sensor communication section 361 of the farm machine 41 and the work mechanism 311 of the implement 42 are disposed at a distance from each other. Thus the work controlling section 321 deploys the sensor 20 at the “work position” offset by the distance between the sensor communication section 361 and the work mechanism 311.

After step S179, control is returned to step S174. The subsequent steps are repeated until work is done on all sensors indicated in the sensor deployment log.

The above-described process permits not only acquisition of the sensor data but also execution of appropriate work in real time based on the sensor status. This contributes to enhancing the efficiency of farm work.

<4. Details of Power Generation by and Communication with the Sensors>

The power generation and communication by the sensors 20 are explained below in detail.

### (Typical Functional Configuration of the Sensor)

As mentioned above, the sensor 20 generates power and is driven thereby to communicate wirelessly with an external device.

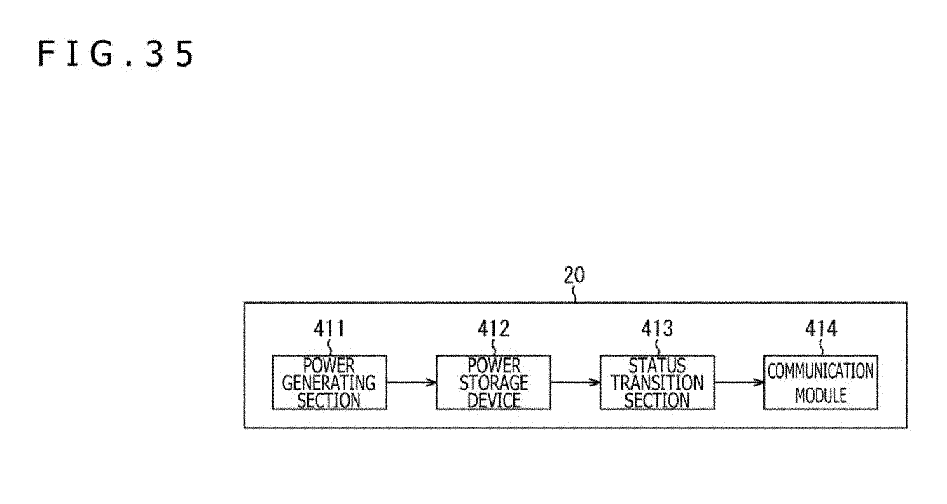

FIG. 35 depicts a typical functional configuration of the sensor 20.

The sensor 20 in FIG. 35 includes a power generating section 411, a power storage device 412, a status transition section 413, and a communication module 414.

The power generating section 411 generates power from the energy that exists in the surrounding environment.

For example, the power generating section 411 generates power from vibrations. The power generation method may be of electrostatic generation type, electromagnetic generation type, inverse-magnetostrictive power generation type, or piezoelectric power generation type, for example.

The power generating section 411 may also generate power from sunlight.

The power generating section 411 may further be a thermoelectric transducer (e.g., a device that generates power by the Seebeck effect or by the Thomson effect, a thermoelectric power generation element, or a device that generates power thermomagnetically) that takes advantage of temperature difference.

The power generating section 411 may also be an enzyme battery that generates power using sugar (also known as a biofuel battery).

The power generating section 411 may further generate power from radio waves. In this case, the power generating section 411 may generate power using a Rectenna or from electromagnetic fields in relatively close proximity through the use of electromagnetic coupling or capacitive coupling that involves using one or some of the LCR (inductance, capacitance, and reactance) components in combination, for example.

The power generating section 411 may also generate power from ion concentration difference.

Obviously, the power generating section 411 may also utilize any known power generation element other than those cited above.

The power storage device 412 stores power generated by the power generating section 411. Note that each sensor 20 may include one or multiple power storage devices 412.

The power storage device 412 may be any one of various secondary batteries including a lithium ion second battery, an electric double-layer capacitor, a lithium ion capacitor, a polyacenic organic semiconductor (Polyacenic Semiconductor) capacitor, a Nanogate capacitor (“Nanogate” is a registered trademark of Nanogate Aktiengesellschaft), a ceramic capacitor, a film capacitor, an aluminum electrolytic capacitor, or a tantalum capacitor. These power storage devices may be used in combination as needed.

The status transition section 413 transitions between different status conditions depending on the power supplied from the power generating section 411. The power from the power generating section 411 may be fed to the status transition section 413 via the above-mentioned power storage device 412 or supplied directly to the status transition section 413. The power generated by the power generating section 411 may be stepped up or down as needed before being fed to the status transition section 413.

The status transition section 413 is configured, for example, as an IC (Integrated Circuit) including one or multiple elements. For example, a switching element such as a transistor, a diode, a reset IC, a regulator IC, a logic IC, or any one of diverse arithmetic circuits may be adopted as the status transition section 413. The circuit configuration inside the IC may be varied as needed as long as the function of the status transition section 413 is implemented thereby.

In accordance with the power fed from the power generating section 411, the status transition section 413 transitions between an on-status condition and an off-status condition, for example. When the power generation amount of the power generating section 411 reaches or exceeds a predetermined level, for example, the status transition section 413 transitions from the off-status condition to the on-status condition. The power generation amount is defined by one or some of voltage, current, electric power, and electric energy in combination. Note that, with the power generating section 411 supplying its power to the status transition section 413 via the power storage device 412, if the power generation amount stored in the power storage device 412 reaches or exceeds a predetermined level, the status transition section 413 transitions from the off-status condition to the on-status condition.

Alternatively, the status transition section 413 may transition among three or more status conditions. The status transition section 413 may preferably be capable of retaining the status reached following each transition. As another alterative, the status transition section 413 may be reset and not retain its status upon transition.

The communication module 414 communicates with an external device different from the sensors 20 (specifically, with the farm equipment system 40 or with the mobile object 50). By communicating with the external device in accordance with a predetermined communication protocol, the communication module 414 outputs predetermined information to that device. Note that the status transition section 413 and the communication module 414 may be connected with a control section so that the communication module 414 may operate under control of the control section. The communication module 414 may alternatively include the control section.

The communication conducted by the communication module 414 is wireless communication. The wireless communication may utilize electromagnetic waves (including infrared rays) or electric fields. Specific wireless communication methods include Wi-Fi, Zigbee (registered trademark), Bluetooth (registered trademark), BLE, ANT (registered trademark), ANT+ (registered trademark), Enocean (registered trademark), Wi-SUN (Wireless Smart Utility Network), Z-Wave, and LTE (Long Term Evolution), each utilizing some of the frequency bands ranging from several-hundred MHz to several GHz. Close proximity communication such as NFC may also be used.

The communication module 414 is activated to conduct communication when the status transition section 413 reaches the on-status condition, for example. The predetermined information to be output by the communication module 414 may, for example, be the sensor ID assigned to each sensor 20 plus a few bits (logical 0 or 1) of information reflecting the status condition of the status transition section 413.

If the power generating section 411 generates power from vibrations, the sensor 20 configured as described above determines whether or not there is an intruder into the farm field given the predetermined information output from the communication module 414. If the power generating section 411 generates power from sunlight, the sensor 20 determines the status of solar irradiation on the farm field given the predetermined information output from the communication module 414. If the power generating section 411 generates power from temperature difference, the sensor 20 determines temperature change on the farm field given the predetermined information output from the communication module 414.

Further, if the power generating section 411 generates power from radio waves, the sensor 20 determines the amount of sugar in the crop on the farm field. In this case, each sensor 20 needs to be deployed in direct contact with the crop. If the power generating section 411 generates power from ion concentration difference, the sensor 20 determines the nutritional status of the crop in the farm field given the predetermined information output from the communication module 414.

Note that, if the communication with the sensor 20 is implemented by wireless communication based on the NFC method, the sensor ID and the user (owner) of each sensor 20 may be registered by the communication. In such a case, even if a sensor 20 is moved from the farm field 10 to another location by theft, for example, the legitimate owner of the sensor 20 can be identified.

Further, if the communication with the sensor 20 is implemented by wireless communication based on the BLE method or using the 920 MHz band, the mobile object 50 may acquire the sensor data in that mode of communication.

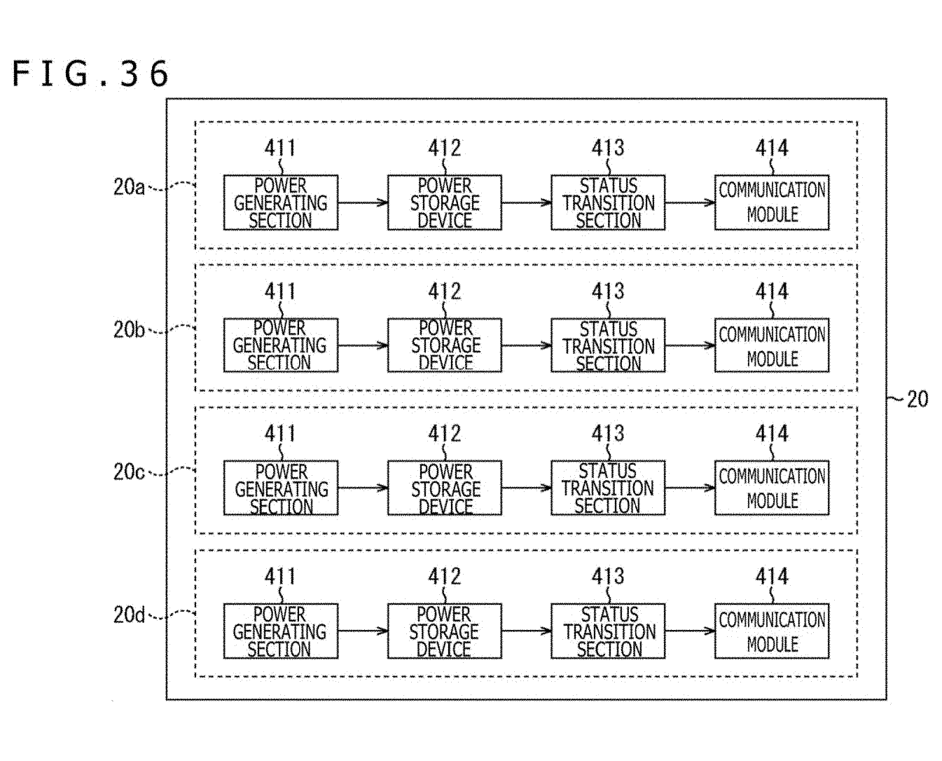

FIG. 36 depicts another typical functional configuration of the sensor 20.

The sensor 20 in FIG. 36 includes multiple modules. In the example of FIG. 36, the sensor 20 includes four modules (modules 20a, 20b, 20c, and 20d). Each module has the structures explained above with reference to FIG. 35. The power generating section 411 of each of the modules generates power based on a different kind of energy.

Each sensor 20 configured as described above is capable of outputting multiple information items on its own.

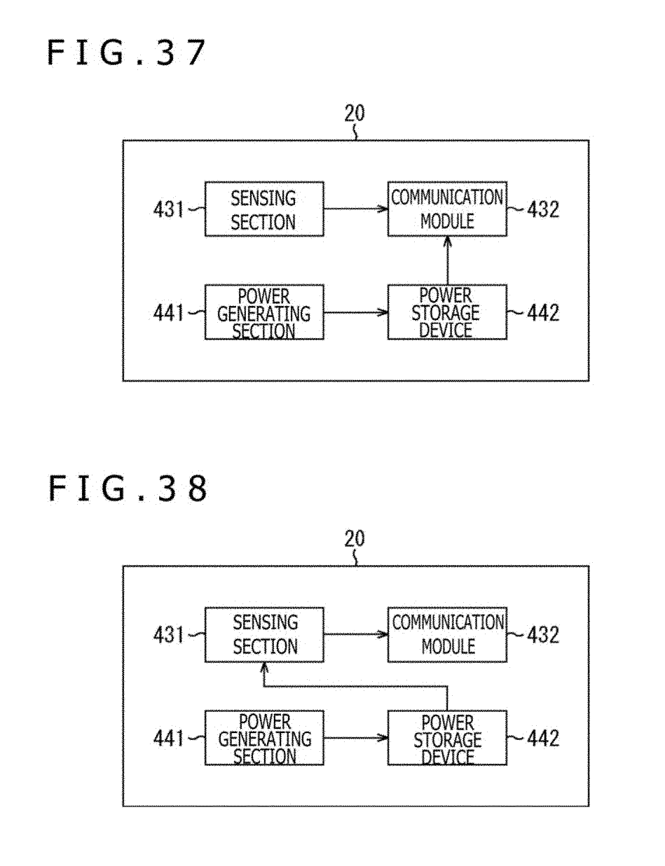

FIG. 37 depicts still another typical functional configuration of the sensor 20.

The sensor 20 in FIG. 37 includes a sensing section 431, a communication module 432, a power generating section 441, and a power storage device 442.

The sensing section 431 has the same functions as those of the power generating section 411, power storage device 412, and status transition section 413 explained above with reference to FIG. 35.

The communication module 432 has the same function as that of the communication module 414 explained above with reference to FIG. 35.

The power generating section 441 and the power storage device 442 have the same functions as those of the power generating section 411 and power storage device 412 explained above with reference to FIG. 35.

In the sensor 20 of FIG. 37, the communication module 432 outputs predetermined information based on the power generated by the sensing section 431. At this point, the communication module 432 can output the predetermined information using the power generated by the power generating section 441 and stored in the power storage device 442.

Further, as depicted in FIG. 38, the sensing section 431 may also be driven by the power generated by the power generating section 441 and stored in the power storage device 442.

Note that, in the configurations of FIGS. 37 and 38, the power supplied from the power generating section 411 may be fed to the communication module 432 and to the sensing section 431 via the above-described power storage device 412 or supplied directly to the communication module 432 and to the sensing section 431.

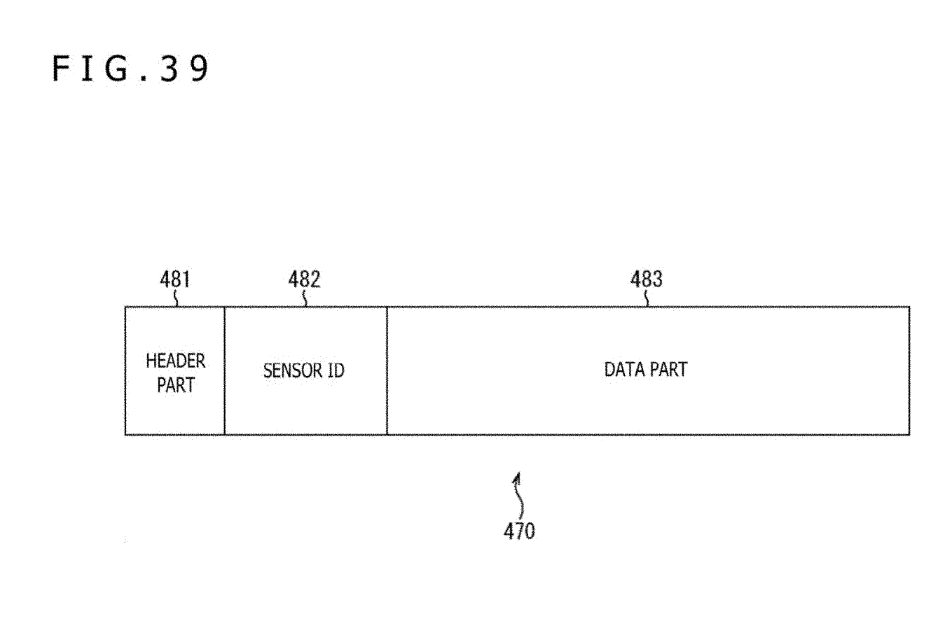

FIG. 39 depicts a typical format of sensor data transmitted by the sensor 20.

As depicted in FIG. 39, the sensor data 470 includes a header part 481, a sensor ID 482, and a data part 483.

The header part 481 is a region that stores header information about the sensor data 470.

The sensor ID 482 is a region that stores information indicative of the ID assigned to each sensor 20 transmitting the sensor data 470.

The data part 483 is a region that stores predetermined information output by the above-mentioned communication module 414. In other words, the data part 483 is a region that stores the information for estimating the status of the sensor 20. The data part 483 may be a variable-length region.

### (Typical Functional Configuration of the Wireless Communication System)

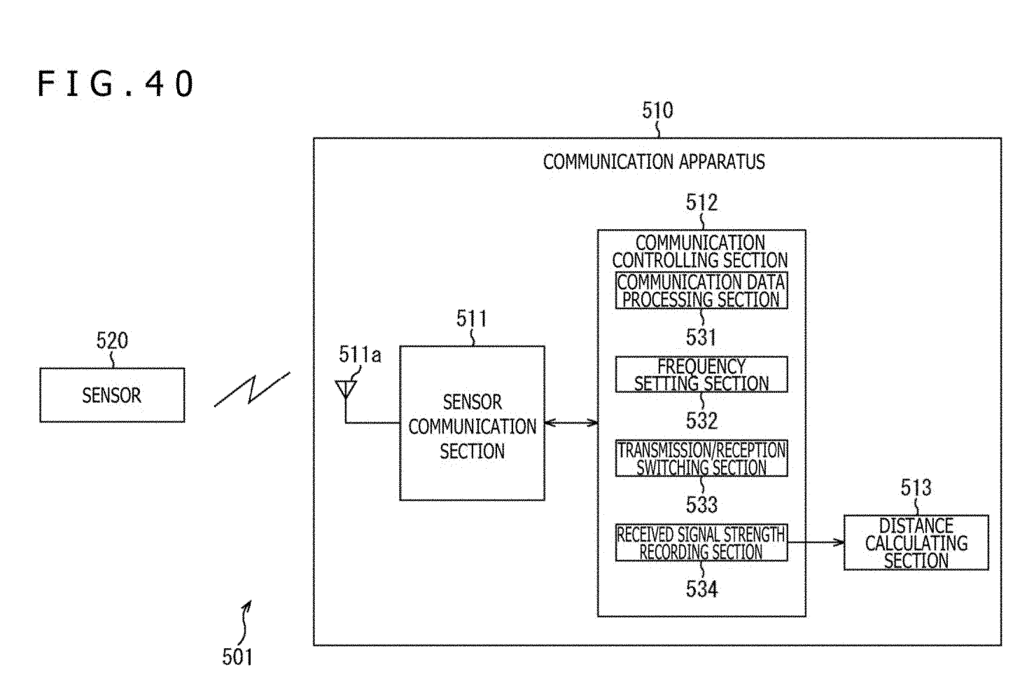

Explained below with reference to FIG. 40 is a typical functional configuration of a wireless communication system that includes a sensor having the similar configuration to that of the above-described sensor 20.

A wireless communication system 501 in FIG. 40 includes a communication apparatus 510 and a sensor 520.

The communication apparatus 510 calculates the distance to the sensor 520 by communicating therewith. Although not depicted, the communication apparatus 510 in the wireless communication system 501 communicates with multiple sensors 520.

The communication apparatus 510 includes a sensor communication section 511, a communication controlling section 512, and a distance calculating section.

The sensor communication section 511 communicates with the sensor 520 by emitting radio waves from an antenna 511a. The communication controlling section 512 controls the sensor communication section 511 in communication.

Further, the communication controlling section 512 includes a communication data processing section 531, a frequency setting section 532, a transmission/reception switching section 533, and a received signal strength recording section 534.

The communication data processing section 531 generates data to be transmitted to the sensor 520 and analyzes data received from the sensor 520.

The frequency setting section 532 sets the frequency of radio waves emitted by the sensor communication section 511 via the antenna 511a.

The transmission/reception switching section 533 switches the operation mode of the sensor communication section 511 to one of two modes: transmission mode in which data is transmitted to the sensor 520, and reception mode in which data is received from the sensor 520.

The received signal strength recording section 534 records the received signal strength of radio waves from the sensor 520 when the sensor communication section 511 receives data from the sensor 520.

The distance calculating section 513 calculates the distance between the communication apparatus 510 and the sensor 520 on the basis of the received signal strength of radio waves from the sensor 520.

### (Distance Calculating Process)

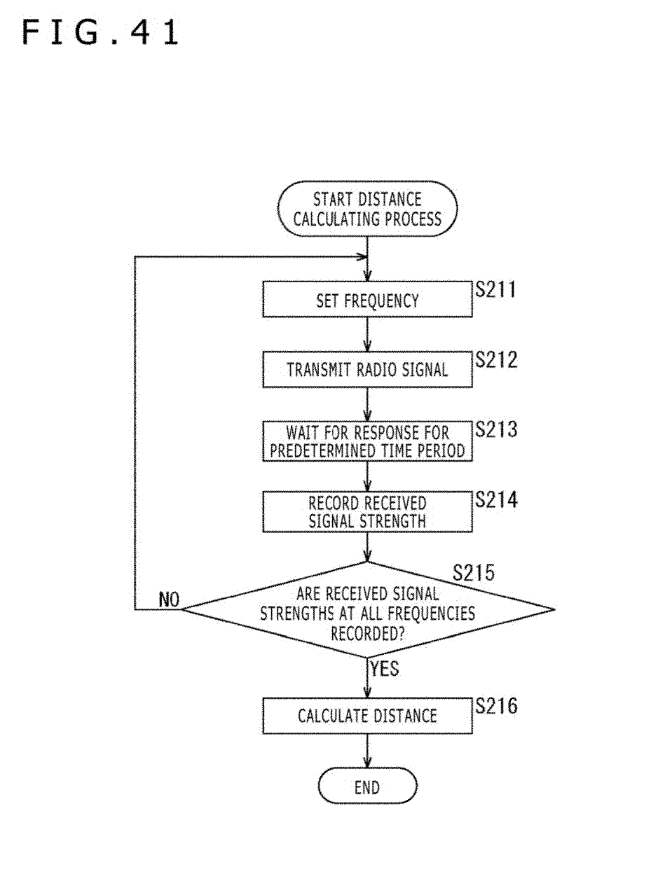

A distance calculating process performed by the wireless communication system 501 is explained below with reference to FIG. 41.

In step S211, the frequency setting section 532 sets the frequency of radio waves emitted by the sensor communication section 511 via the antenna 511a to a predetermined frequency in a predetermined frequency range.

The frequency to be set by the frequency setting section 532 may be one in the 60 GHz band, 5 GHz band, 2.4 GHz band, 920 MHz band, or 13.56 MHz band, for example. Alternatively, a frequency in a low-frequency band used for Morse code communication may be set as the frequency set by the frequency setting section 532.

Furthermore, the frequency to be set by the frequency setting section 532 may be one in the 135 MHz band or 920 MHz band used in RFID (Radio Frequency Identifier) applications; one in the 13.56 MHz band, 40.5 MHz band, 2.45 GHz band, 5.8 GHz band, or 20 GHz band from among ISM (Industry Science Medical) bands; one in the 313 MHz band, 430 MHz band, 806 MHz band, 1.2 GHz band, or 60 GHz band used in specified low-power radio applications; one in the 5.35 GHz band used on wireless LANs (local area networks); or one in a bandwidth ranging from 300 GHz to 3 THz not assigned to general applications.

If the operation mode of the sensor communication section 511 is switched to transmission mode by the transmission/reception switching section 533, control is transferred to step S212. In step S212, the sensor communication section 511 transmits a radio signal to the sensor 520 via the antenna 511a using the radio wave frequency set by the frequency setting section 532.

If the operation mode of the sensor communication section 511 is switched to reception mode by the transmission/reception switching section 533, control is transferred to step S213. In step S213, the communication controlling section 512 waits for a response from the sensor 520 for a predetermined time period.

Thereafter, when the sensor communication section 511 receives radio waves as a response from the sensor 520, control is transferred to step S214. In step S214, the received signal strength recording section 534 records the received signal strength of radio waves from the sensor 520.

In step S215, the received signal strength recording section 534 determines whether or not the received signal strengths of radio waves have been recorded at all frequencies in the predetermined frequency range.

If it is determined that the received signal strengths of radio waves have yet to be recorded at all frequencies, control is returned to step S211. In step S211, the frequency setting section 532 sets another frequency in the predetermined frequency range. The subsequent steps are then repeated.

If it is determined in step S215 that the received signal strengths of radio waves have been recorded at all frequencies, control is transferred to step S216.

In step S216, the distance calculating section 513 calculates the attenuation of radio waves at each of the frequencies involved from the received signal strengths recorded. The distance calculating section 513 calculates the distance to the sensor 520 in accordance with the radio wave attenuation at each frequency.

Specifically, the distance calculating section 513 first calculates a propagation loss (attenuation) L (dB) using the following mathematical expression (1):

Pr=Pt+Gt+Gr−L (1)

The mathematical expression (1) above is a propagation equation for the wireless communication system. In the mathematical expression (1), Pr stands for received signal strength, Pt for transmission power, Gt for transmitting antenna gain, and Gr for receiving antenna gain.

The distance calculating section 513 then calculates a transmission-reception distance d(m) using the following mathematical expression (2):

L=20 log f+20 log d−27.6 (2)

The mathematical expression (2) above is an approximation of the propagation loss over a line-of-sight communication channel (Friis transmission formula). In the mathematical expression (2), f(MHz) stands for frequency.

Note that, if the wireless communication channel involved is an over-the-horizon communication channel, the transmission-reception distance d(m) is calculated using the following mathematical expression (3):

L=20 log f+N log d+Lf(n)−28 (3)

The mathematical expression (3) above is an approximation of the propagation loss over an over-the-horizon communication channel (Recommendation ITU-R P1238). In the mathematical expression (3), f(MHz) stands for frequency, N for the attenuation coefficient for the transmission-reception distance, Lf for the additional loss incurred upon transmission through floors, ceilings, walls, etc., and n for the number of transmitted floors, ceilings, walls, etc. The additional loss Lf is dependent on the number n.

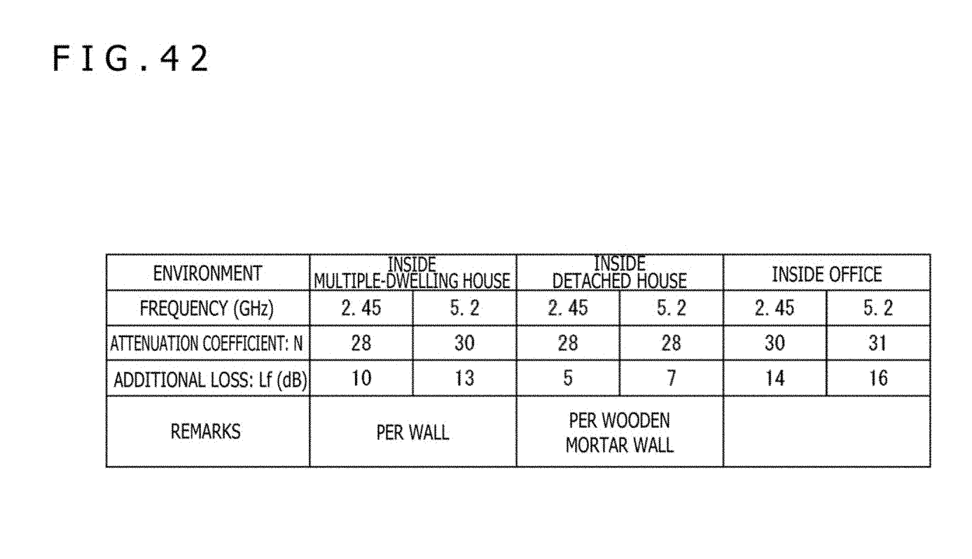

As depicted in FIG. 42, the attenuation coefficient N and the additional loss Lf are determined by the environment in which wireless communication is conducted and by the frequency of radio waves in use.

For example, if the environment where wireless communication is conducted is inside a multiple-dwelling house and if the radio wave frequency is 2.45 GHz, the attenuation coefficient N is 28 and the additional loss Lf is 10. If the radio wave frequency is 5.2 GHz, the attenuation coefficient N is 30 and the additional loss Lf is 13. Note that these values are applicable where there is one wall.

If the environment where wireless communication is conducted is inside a detached house and if the radio wave frequency is 2.45 GHz, the attenuation coefficient N is 28 and the additional loss Lf is 5. If the radio wave frequency is 5.2 GHz, the attenuation coefficient N is 28 and the additional loss Lf is 7. These values are applicable where there is one wooden mortar wall.

If the environment where wireless communication is conducted is inside an office and if the radio wave frequency is 2.45 GHz, the attenuation coefficient N is 30 and the additional loss Lf is 14. If the radio wave frequency is 5.2 GHz, the attenuation coefficient N is 31 and the additional loss Lf is 16.

This is how the distance between the communication apparatus 510 and each of multiple sensors 520 is calculated.

In recent years, there has been a push to transition to what is known as a trillion-sensor society making use of as many as trillion sensors. In such a trillion-sensor society or similar wireless sensor networks involving the use of numerous sensors, it is necessary to measure the distance to each sensor. However, existing measuring techniques that use only the received signal strength of radio waves have failed to ensure sufficient measurement accuracy.

In contrast, the above-described process permits transmission and reception to and from each sensor by switching from one frequency to another in order to calculate the distance to the sensor from the attenuation of radio waves at each frequency. For example, even if the transmitting antenna gain Gt or the receiving antenna gain Gr has a null point in a specific direction in the mathematical expression (1) above depending on the antenna direction distribution at a given frequency, measurements taken at multiple frequencies enable statistical processing to be carried out. As a result, the distance to each sensor is measured with higher accuracy than before.

It is explained above that the transmitting side (communication apparatus 510) measures the distance based on the received signal strength of radio waves from the receiving side (sensor 520). Alternatively, the receiving side may measure the distance based on the received signal strength of radio waves from the transmitting side and send the measurements to the transmitting side.

### (Another Typical Functional Configuration of the Wireless Communication System)

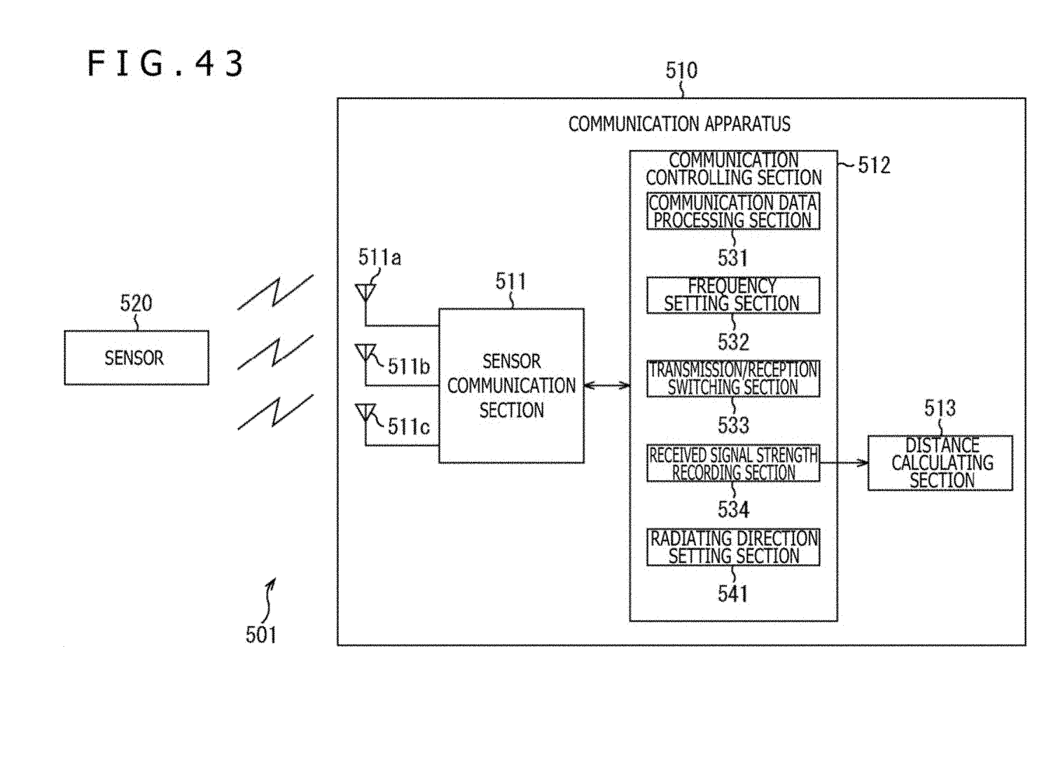

Another typical functional configuration of the wireless communication system is explained below with reference to FIG. 43. Note that the structures having the similar functions to those discussed above are given the same names and designated by the same reference signs, and these structures will not be discussed further.

In the wireless communication system 501 of FIG. 43, the sensor communication section 511 includes multiple antennas 511a, 511b and 511c. Although FIG. 43 illustrates only three antennas, there may be provided eight or 16 antennas in practice. That is, the antennas 511a to 511c function as a multidirectional antenna having directivity in multiple directions.

For example, the antennas 511a to 511c are configured as a phased-array antenna or as a sector antenna. The antennas 511a to 511c may alternatively be configured as an antenna setup for conducting MIMO (Multi-Input Multi-Output) communication.

The communication controlling section 512 further includes a radiating direction setting section 541 in addition to the similar configuration to that depicted in FIG. 40.

The radiating direction setting section 541 sets the radiating direction of radio waves emitted by the sensor communication section 511 via the antennas 511a to 511c configured as a multidirectional antenna.

### (Distance Calculating Process)

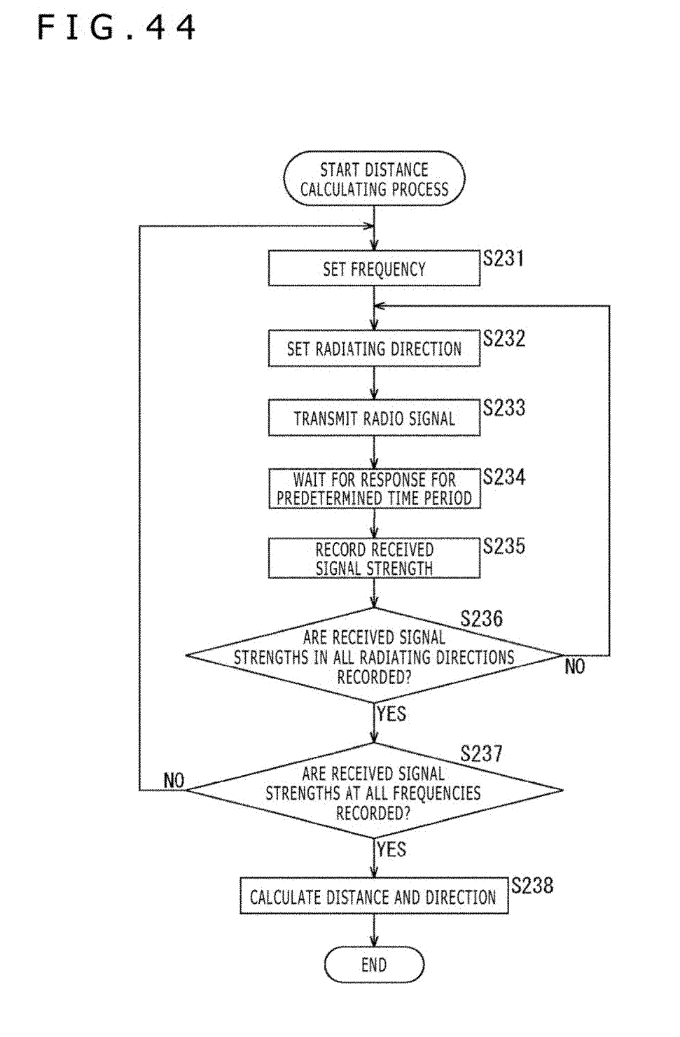

Explained below with reference to the flowchart of FIG. 44 is a distance calculating process performed by the wireless communication system 501 in FIG. 43.

Note that, in the flowchart of FIG. 44, steps S231, S233 to S235, and S237 are the similar to steps S211 to S215 in the flowchart of FIG. 41 and thus will not be discussed further.

In step S232, the radiating direction setting section 541 sets the radiating direction of radio waves emitted by the sensor communication section 511 via the antennas 511a to 511c to a specific direction in a predetermined range.

In step S236, the received signal strength recording section 534 determines whether or not the received signal strengths of radio waves have been recorded in all radiating directions in the predetermined range.

If it is determined that the received signal strengths have yet to be recorded in all radiating directions, control is returned to step S232. In step S232, the radiating direction setting section 541 sets the radiating direction to another direction in the predetermined range. Steps S233 to S235 are then repeated.

On the other hand, if it is determined in step S236 that the received signal strengths have been recorded in all radiating directions, control is transferred to step S237.

If it is determined in step S237 that the received signal strengths have been recorded at all frequencies, control is transferred to step S238.

In step S238, the distance calculating section 513 calculates the attenuation of radio waves in each radiating direction at each frequency from the received signal strengths recorded. The distance calculating section 513 calculates the distance to the sensor 520 and the direction in which the sensor 520 is deployed on the basis of the attenuation of radio waves at each frequency and in each radiating direction.

In the above-described process, the transmission and reception to and from the sensor are carried out at one frequency after another and in one radiating direction after another. The distance to the sensor and the direction in which the sensor is deployed are calculated on the basis of the attenuation of radio waves at each frequency and in each radiating direction. This allows the distance to each sensor to be measured and the direction of the sensor position to be detected with higher accuracy than before.

### (Still Another Typical Functional Configuration of the Wireless Communication System)

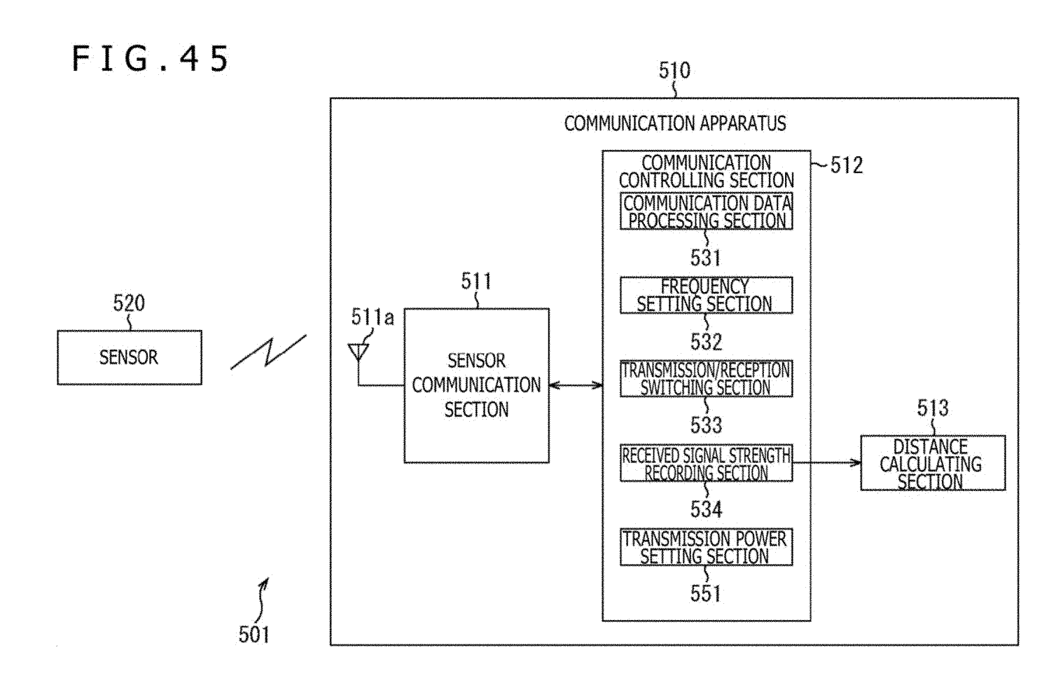

Still another typical functional configuration of the wireless communication system is explained below with reference to FIG. 45. Note that the structures having the similar functions to those discussed above are given the same names and designated by the same reference signs, and these structures will not be discussed further.

In the wireless communication system 501 of FIG. 45, the communication controlling section 512 includes a transmission power setting section 551 replacing the radiating direction setting section 541 depicted in FIG. 43.

The transmission power setting section 551 sets the transmission power used by the sensor communication section 511 in emitting radio waves via the antenna 511a.

### (Distance Calculating Process)

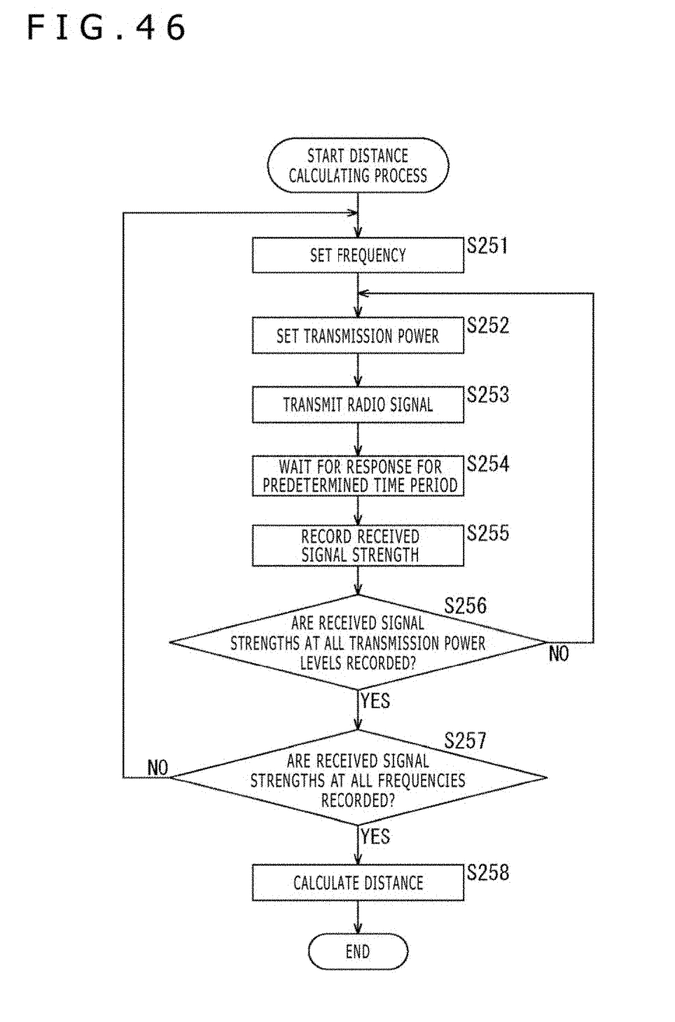

A distance calculating process performed by the wireless communication system 501 in FIG. 45 is explained below with reference to the flowchart of FIG. 46.

In the flowchart of FIG. 46, the processes of steps S251, S253 to S255, and S257 are similar to those of steps S231, S233 to S235, and S237 in the flowchart of FIG. 44 and thus will not be discussed further.

That is, in step S252, the transmission power setting section 551 sets the transmission power used by the sensor communication section 511 in emitting radio waves via the antenna 511a to a specific power level in a predetermined range.

In step S256, the received signal strength recording section 534 determines whether or not the received signal strengths of radio waves have been recorded on all transmission power levels in the predetermined range.

If it is determined that the received signal strengths of radio waves have yet to be recorded on all transmission power levels, control is returned to step S252. In step S252, the transmission power setting section 551 sets the transmission power to another power level in the predetermined range. Steps S253 to S255 are then repeated.

On the other hand, if it is determined in step S256 that the received signal strengths have been recorded on all transmission power levels, control is transferred to step S257.

If it is determined in step S257 that the received signal strengths have been recorded at all frequencies, control is transferred to step S258.

In step S258, the distance calculating section 513 calculates the attenuation of radio waves at each frequency and on each transmission power level from the received signal strengths recorded. The distance calculating section 513 then calculates the distance to the sensor 520 on the basis of the attenuation of radio waves at each frequency and on each transmission power level.

In the above-described process, the transmission and reception to and from the sensor are carried out at one frequency after another and on one transmission power level after another. The distance to the sensor is calculated on the basis of the attenuation of radio waves at each frequency and on each transmission power level. This allows the distance to each sensor to be measured with higher accuracy than if the distance to each sensor is calculated from the attenuation of radio waves at each frequency.

Note that combining the above-described distance calculating process with common triangulation techniques makes it possible to measure the distance with still higher accuracy than before.

What is explained above is a configuration that performs the transmission and reception to and from the sensor at one frequency after another so as to calculate the distance to the sensor from the attenuation of radio waves at each frequency. Alternatively, the status of each sensor may be estimated from the attenuation of radio waves at each frequency.

(Typical Functional Configuration of the Wireless Communication System that Estimates the Sensor Status)

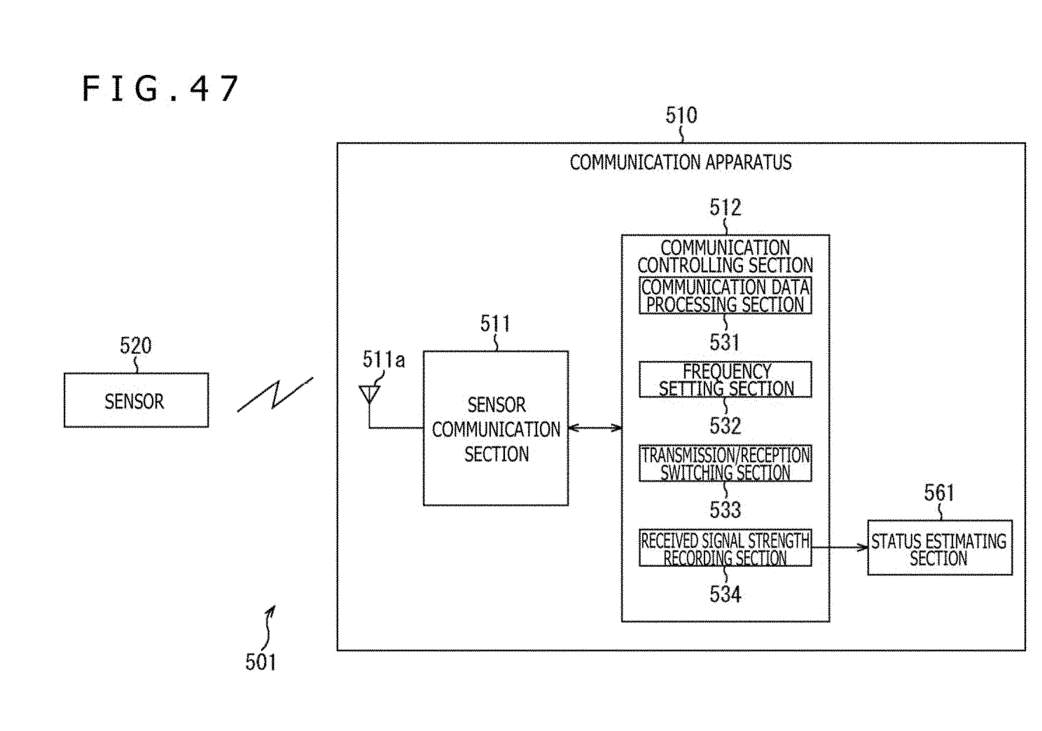

A typical functional configuration of a wireless communication system that estimates the sensor status is explained below with reference to FIG. 47. Note that the structures having the similar functions to those discussed above are given the same names and designated by the same reference signs, and these structures will not be discussed further.

In the wireless communication system 501 of FIG. 47, the communication controlling section 512 includes a status estimating section 561 replacing the distance calculating section 513 in FIG. 40.

The status estimating section 561 estimates the status of each sensor 520 on the basis of the received signal strength of radio waves from that sensor 520.

### (Status Estimating Process)

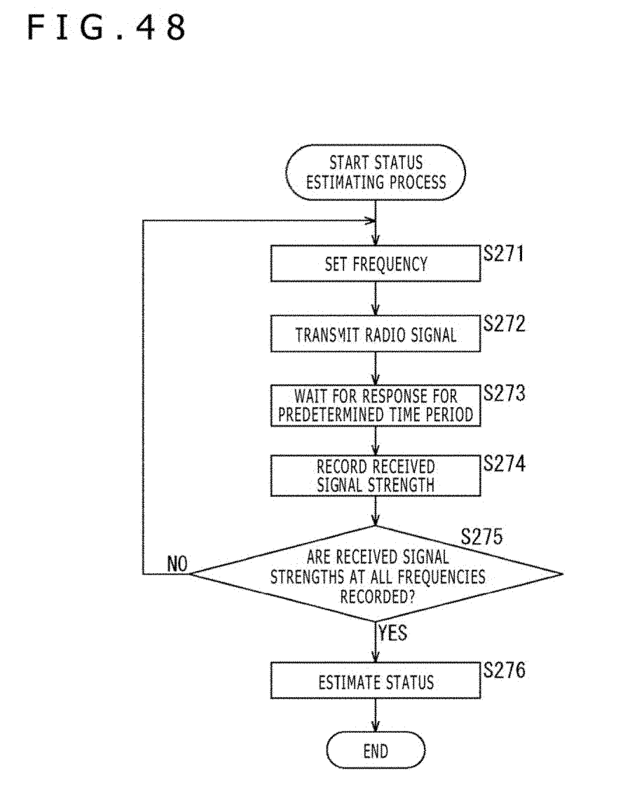

Explained below with reference to the flowchart of FIG. 48 is a status estimating process performed by the wireless communication system 501 in FIG. 47.

In the flowchart of FIG. 48, the processes of steps S271 to S275 are similar to those of steps S211 to S215 in the flowchart of FIG. 41 and thus will not be discussed further.

That is, if it is determined in step S275 that the received signal strengths have been recorded at all frequencies, control is transferred to step S276.

In step S276, the distance calculating section 513 calculates the attenuation of radio waves at each frequency from the received signal strengths recorded. The distance calculating section 513 then estimates the status of the sensor 520 on the basis of the attenuation of radio waves at each frequency.

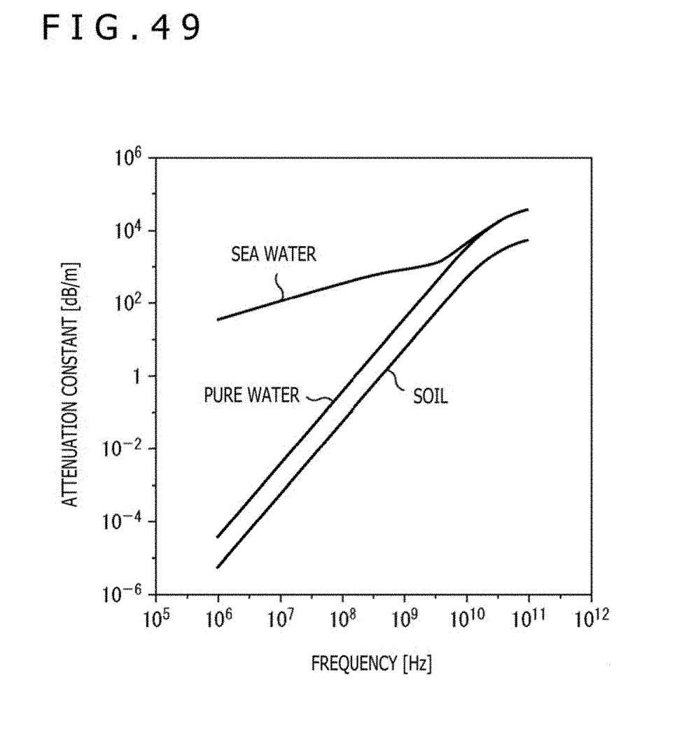

FIG. 49 depicts the relations between radio wave frequencies and attenuation constants of radio waves propagating through different media.

In FIG. 49, the attenuation constant stands for the attenuation of radio waves per meter.

As depicted in FIG. 49, the attenuation constant at approximately 100 GHz in the soil ranges approximately from 1,000 to 10,000 dB/m. The attenuation constant drops in proportion to the decrease in frequency. At approximately 1 MHz, the attenuation constant ranges approximately from 1 to 10 μdB/m.

In pure water, the attenuation constant at approximately 100 GHz ranges approximately from 10,000 to 100,000 dB/m. As in the soil, the attenuation constant drops in proportion to the decrease in frequency. At approximately 1 MHz, the attenuation constant ranges approximately from 10 to 100 μdB/m.

In sea water, as in pure water, the attenuation constant at approximately 100 GHz ranges approximately from 10,000 to 100,000 dB/m. As in pure water, the attenuation constant in sea water drops in proportion to the decrease in frequency to approximately 10 GHz. However, past 5 GHz or thereabouts, the attenuation constant drops less precipitously, ranging approximately from 10 to 100 dB/m at approximately 1 MHz.

The status estimating section 561 estimates the status of the sensor 520 in accordance with which of the curves depicted in FIG. 49 approximates the attenuation of radio waves at each frequency. This makes it possible to determine, for example, whether the environment in which the sensor 520 exists is in the soil, in water, or in sea water.

In the above-described process, the transmission and reception to and from each sensor are carried out at one frequency after another. The status of the sensor is estimated from the attenuation of radio waves at each frequency. This permits detection of the environment in which each sensor exists.

Note that, where the sensor is in a medium such as the soil or water in which the attenuation of radio waves is pronounced, the distance calculating process explained above may not ensure correct measurement of the distance. In such a case, the distance calculating process may be performed in a manner reflecting the sensor status (environment) estimated by the status estimating process. This contributes to enhancing the reliability of distance measurement.

The wireless communication system 501 in FIG. 47 may be applied to the farm field management system 1 explained above with reference to FIG. 1 in particular. In this case, the status estimating section 561 functions as the status estimating section 351 (FIG. 20) of the server 80 or as the status estimating section 351 (FIG. 32) of the farm machine 41. This configuration permits detection of whether the sensor 20 is deployed in the ground or on the ground surface. At this point, the above-described distance calculating process may be performed by the farm field management system 1.

Further, the sensor 520 of the wireless communication system 501 in FIG. 47 may be mounted on a wearable device. This arrangement makes it possible to detect whether a user wearing the wearable device has fallen into the sea or been caught in a landslide disaster, for example.

### <5. Recovery of the Sensors>

With the farm field management system 1, leaving the sensors 20 unrecovered on the farm field after the harvest of crops is not desirable on environmental and cost grounds.

Explained below are configurations and processes for recovering the sensors deployed on the farm field.

### (Typical Functional Configuration of the Farm Equipment System)

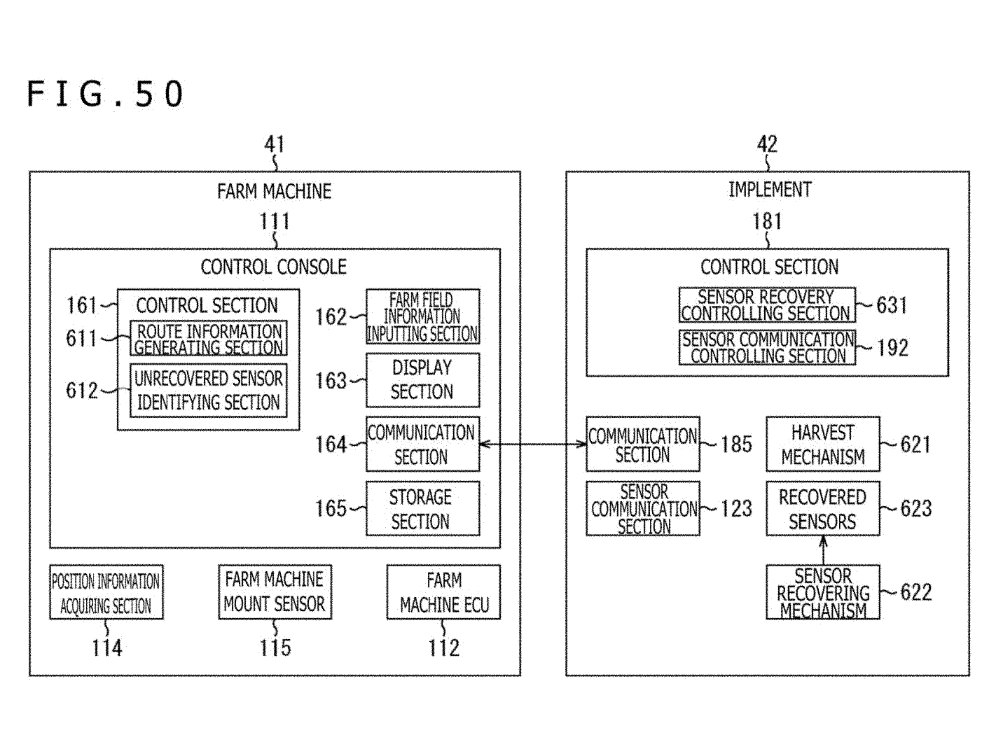

FIG. 50 depicts a typical functional configuration of the farm equipment system 40 for recovering the sensors deployed on the farm field. Note that the structures having the similar functions to those discussed above are given the same names and designated by the same reference signs, and these structures will not be discussed further.

In the farm machine 41 of FIG. 50, the control section 161 of the control console 111 includes a route information generating section 611 and an unrecovered sensor identifying section 612.

The route information generating section 611 generates route information indicative of the route along which the farm equipment system 40 recovers the sensors 20 deployed on the farm field 10. The unrecovered sensor identifying section 612 identifies the sensors 20 not recovered by the farm equipment system 40.

The implement 42 includes a harvest mechanism 621 and a recovering mechanism 622 as the implement mechanism.

The harvest mechanism 621 has the function of harvesting crops from the farm field 10.

The sensor recovering mechanism 622 has the function of recovering the sensors 20 deployed on the farm field 20. The sensors 20 recovered by the sensor recovering mechanism 622 are stored into the implement 42 as recovered sensors 623.

Further, the control section 181 of the implement 42 includes a sensor recovery controlling section 631 replacing the sensor deployment controlling section 191 (FIG. 9).

The sensor recovery controlling section 631 controls the sensor recovering mechanism 622. Specifically, the sensor recovery controlling section 631 causes the sensor recovering mechanism 622 to recover the sensors 20 in accordance with the sensor deployment log generated by the log generating section 174 (FIG. 9). The sensor deployment log may be the “sensor deployment positions” updated during work on the farm field. Specifically, the sensor deployment log may be the “sensor deployment positions” updated in the sensor data acquiring process (FIG. 21).

Note that the sensor communication section 123 in FIG. 50 can communicate not only with the sensors 20 deployed on the farm field 10 but also with the sensors 20 stored in the sensor recovering mechanism 622. At this point, the communication method and the frequency band of the communication with the sensors 20 deployed on the farm field 10 are different from those of the communication with the sensors 20 stored in the sensor recovering mechanism 622. Specifically, the sensor communication section 123 and each sensor 20 deployed on the farm field 10 communicate with each other using the M2M communication frequency band because of certain distances required therebetween. On the other hand, the sensor communication section 123 and each sensor 20 stored in the sensor recovering mechanism 622 communicate with one another using NFC. When such different communication methods are adopted, congestion of traffic is reduced in communication with the numerous sensors 20 stored in a narrow space such as the sensor recovering mechanism 622.

Alternatively, each sensor 20 may be equipped with a communication section similar to the sensor communication section 123, and different communication methods such as those discussed above may be adopted for the communication with the sensors 20.

### (Sensor Recovering Process)

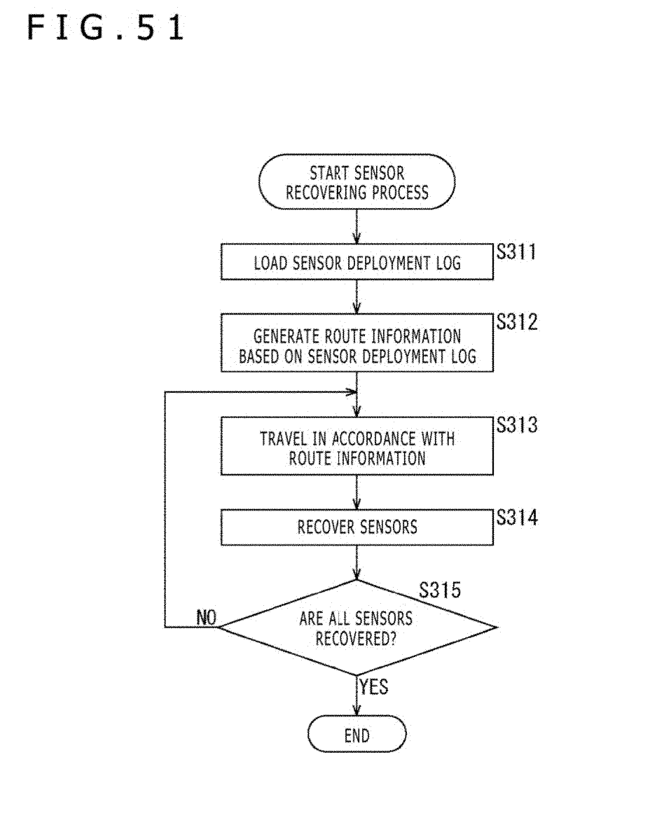

A sensor recovering process is explained below with reference to the flowchart of FIG. 51. This process is started by the user operating the control console 111, for example.

In step S311, the control console 111 loads the sensor deployment log from the storage section 165. At this point, the seeding log may also be loaded along with the sensor deployment log. Note that the sensor deployment log may be the information generated when the sensor deploying mechanism 184 deploys the sensors 20 in the sensor deploying process. The sensor deployment log may also be the information generated when the sensor communication section 336 (sensor communication section 361) acquires the sensor data from the sensors 20 in the sensor data acquiring process.

In step S312, the route information generating section 611 generates route information for recovering the sensors 20 deployed on the farm field in accordance with the loaded sensor deployment log. At this point, the route information generating section 611 uses width information indicative of a width (range) within which the sensor recovering mechanism 622 of the implement 42 can recover a sensor 20 upon travel over a given point along the route. That is, the route information generating section 611 generates the route information for recovering the sensors 20 deployed on the farm field using the loaded sensor deployment log and width information. The width information may be acquired either from the input to the terminal apparatus 60 or the control console 111 made by the user or through reception from the implement 42 via the communication section 164.

If the travel of the farm equipment system 40 is designated at this point by the user operating the control console 111, for example, the farm equipment system 40 in step S313 travels in accordance with the route information.

When the current position acquired by the position information acquiring section 114 of the farm equipment system 40 reaches the position indicated by a given sensor deployment position in the sensor deployment log, the sensor recovery controlling section 631 in step S314 controls the sensor recovering mechanism 622 to recover the sensor 20 from that position.

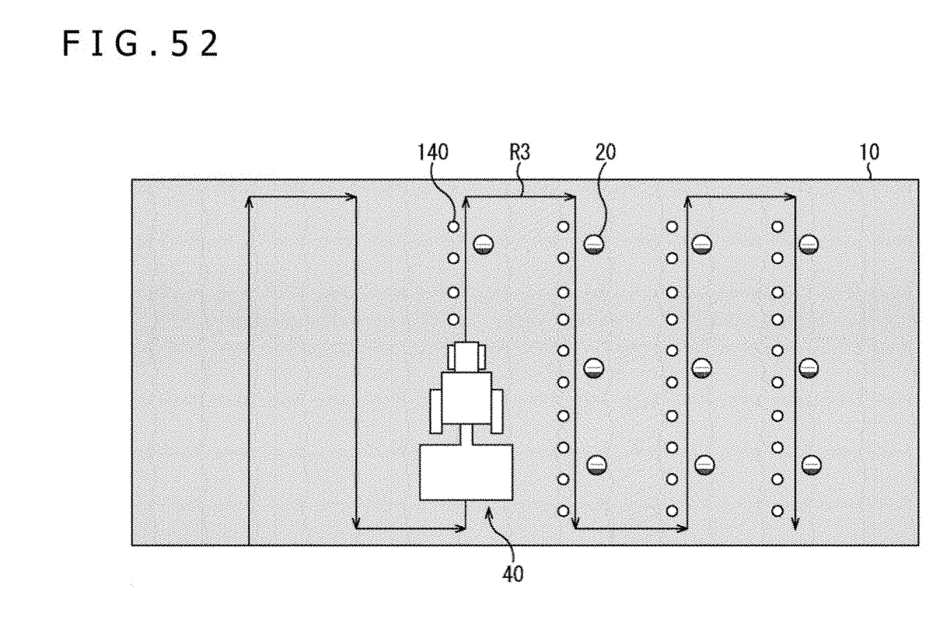

FIG. 52 is a schematic diagram explaining a travel route at the time of recovering sensors.

The example of FIG. 52 depicts arrows R3 indicating the route traveled by the farm equipment system 40 in accordance with the route information. Traveling along the travel route R3 across the farm field, the farm equipment system 40 comes to the position where each sensor 20 is deployed and thereupon recovers the sensor 20.

In step S315, the control console 111 determines whether or not all sensors 20 have been recovered in accordance with the loaded sensor deployment log.

If it is determined that not all sensors 20 have been recovered yet, control is returned to step S313. The subsequent steps are then repeated.

If it is determined that all sensors 20 have been recovered, on the other hand, the process is terminated. At this point, the sensor communication section 123 communicates by NFC with the recovered sensors 623 to acquire their sensor IDs and feeds the acquired sensor IDs to the storage section 165 of the farm machine 41 via the communication section 185, for example.

In the flowchart of FIG. 51, the crop 140 may be harvested by the harvest mechanism 621 in parallel with the recovery of the sensors 20.

In the above-described process, the sensors deployed on the farm field are recovered after or during the harvest of the crop. With no sensors left unrecovered on the farm field, the impact on the environment is minimized. Since the recovered sensors are reusable, cost reduction is accomplished.

If some sensors are left unrecovered following the sensor recovering process discussed above, an unrecovered sensor recovering process is carried out to recover the left-out sensors.

### (Unrecovered Sensor Recovering Process)

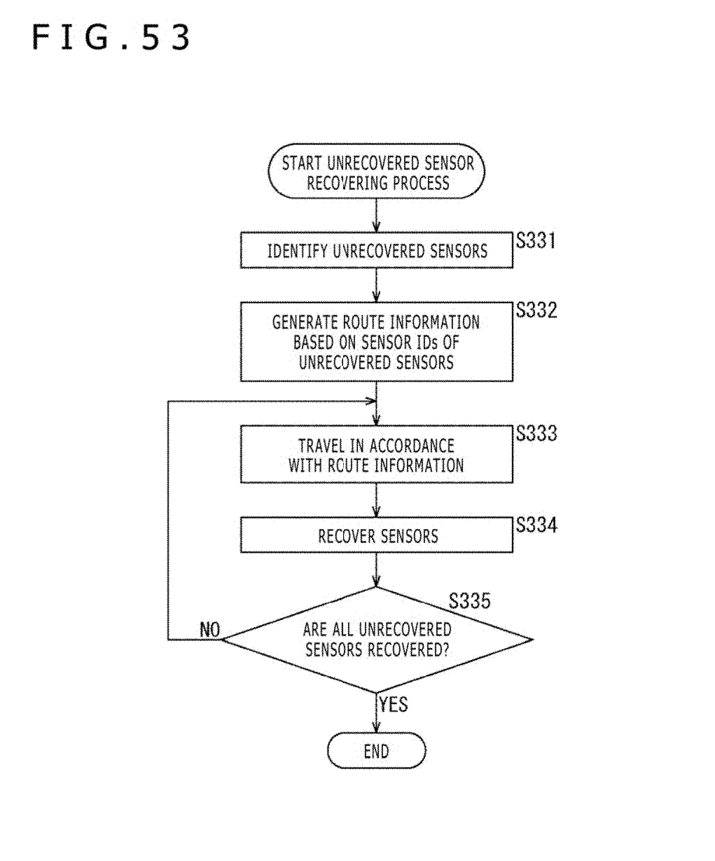

The unrecovered sensor recovering process is explained below with reference to the flowchart of FIG. 53. This process is started by the user operating the control console 111, for example.

In step S331, the control console 111 loads the sensor deployment log and the sensor IDs of the recovered sensors 623 from the storage section 165 of the farm machine 41. The sensor IDs of the recovered sensors 623 may alternatively be acquired by the sensor communication section 123 communicating with the recovered sensors 623. The unrecovered sensor identifying section 612 identifies the unrecovered sensors 20 based on the differences between the sensors IDs in the sensor deployment log on the one hand and the sensor IDs of the recovered sensors 623 on the other hand.

In step S312, the route information generating section 611 generates route information on the basis of the identified sensor IDs of the unrecovered sensors 20. Specifically, the route information generating section 611 generates the route information indicative of a route connecting the sensor deployment positions associated with the sensor IDs of the unrecovered sensors 20 in the sensor deployment log. At this point, the route information generating section 611 generates the route information for recovering the unrecovered sensors 20 using the sensor deployment log and the above-mentioned width information. At this point, the width information may also be acquired either from the input to the terminal apparatus 60 or to the control console 111 made by the user or through reception from the implement 42 via the communication section 164.

If the travel of the farm equipment system 40 is designated at this point by the user operating the control console 111, for example, the farm equipment system 40 in step S333 travels in accordance with the route information.

When the current position acquired by the position information acquiring section 114 of the farm equipment system 40 reaches the position indicated by a given sensor deployment position associated with the sensor ID of an unrecovered sensor 20 in the sensor deployment log, the sensor recovery controlling section 631 in step S334 controls the sensor recovering mechanism 622 to recover the sensor 20 from that position.

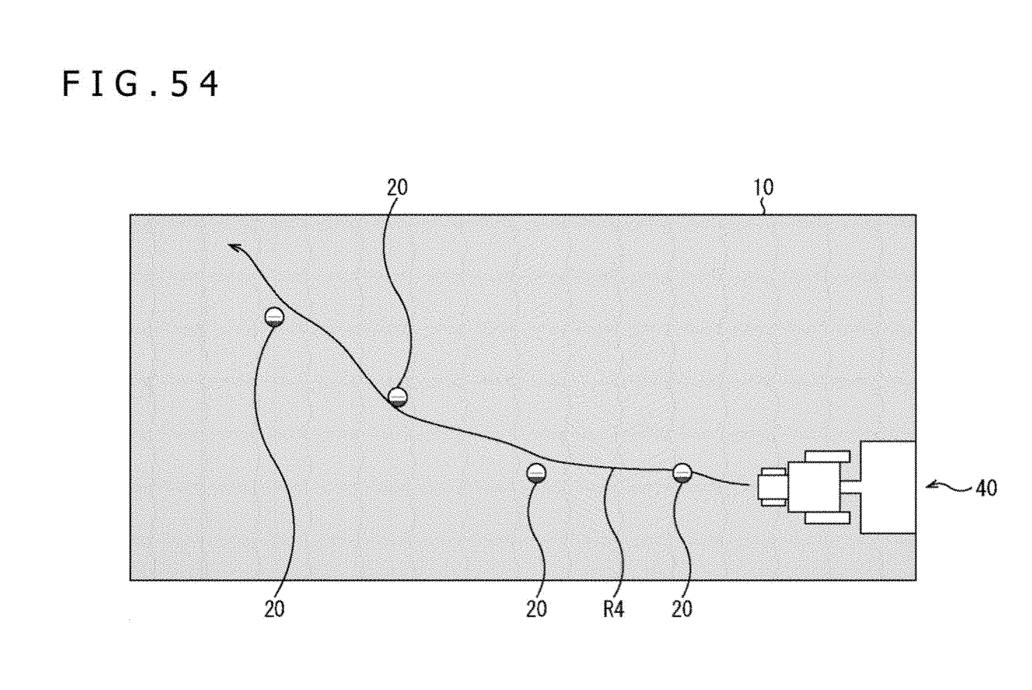

FIG. 54 is a schematic diagram explaining a travel route at the time of recovering the unrecovered sensors.

The example of FIG. 54 depicts arrows R4 indicating the route traveled by the farm equipment system 40 in order to recover four unrecovered sensors 20. Traveling along the travel route R4 across the farm field, the farm equipment system 40 comes to the position where each unrecovered sensor 20 is located and thereupon recovers the sensor 20 from the position.

In step S335, the control console 111 determines whether or not all unrecovered sensors 20 have been recovered in accordance with the loaded sensor deployment log.

If it is determined that not all unrecovered sensors 20 have been recovered yet, control is returned to step S333. The subsequent steps are then repeated.

If it is determined that all unrecovered sensors 20 have been recovered, on the other hand, the process is terminated.

In the above-described process, the sensors left unrecovered are recovered. As a result, cost reduction is accomplished more reliably without impacting on the environment.

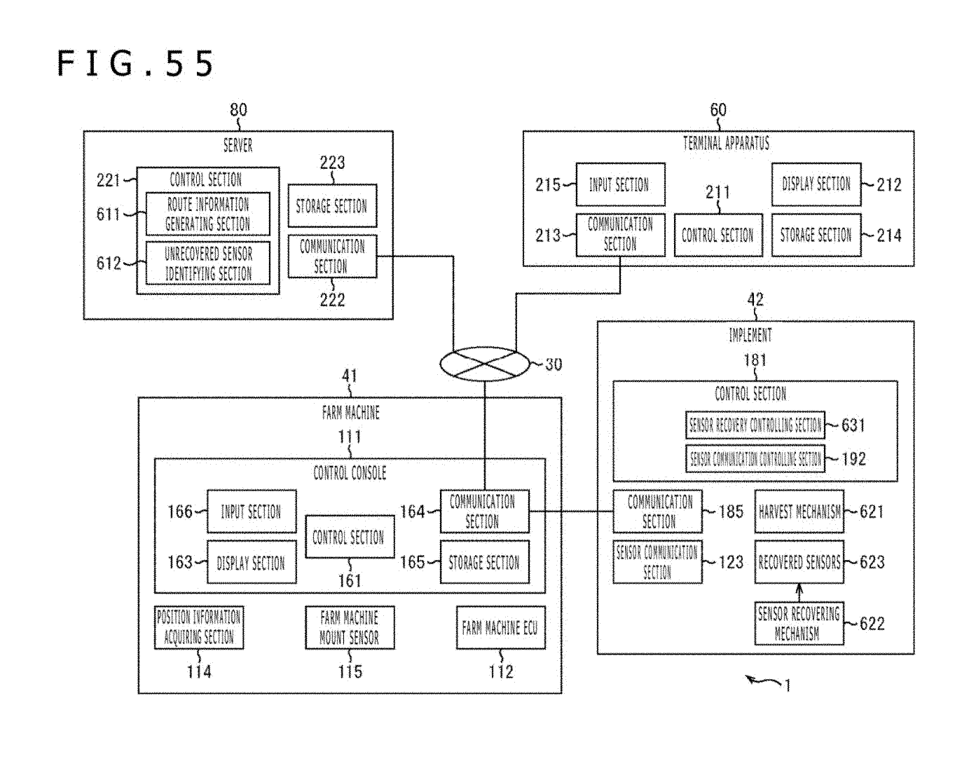

It is explained above that the farm equipment system 40 performs the sensor recovering process and the unrecovered sensor recovering process. Alternatively, the farm field management system 1 depicted in FIG. 55 may carry out the sensor recovering process and the unrecovered sensor recovering process.

The farm field management system 1 configured as illustrated enables the farm equipment system 40 (farm machine 41 and implement 42) and the server 80 to perform the sensor recovering process and the unrecovered sensor recovering process.

Embodiments of the present technology are not limited to the embodiments described above and may be varied or modified diversely within the spirit and scope of the present technology.

For example, the present technology may be implemented as a cloud computing setup in which a single function is processed cooperatively by multiple networked apparatus on a shared basis.

Also, each of the steps discussed in reference to the above-described flowcharts may be executed either by a single apparatus or by multiple apparatus on a shared basis.

Furthermore, if a single step includes multiple processes, these processes may be executed either by a single apparatus or by multiple apparatus on a shared basis.

Further, the present technology may be configured as follows:

(1)

A farm field management system including:

a sensor position calculating section configured to calculate a sensor position at which a sensor is deployed on a farm field on the basis of farm field information; and

a sensor deployment controlling section configured to control a sensor deploying mechanism that deploys the sensor on the farm field to deploy the sensor in accordance with the sensor position.

(2)

The farm field management system as stated in paragraph (1) above, further including:

an instruction information generating section configured to generate instruction information for causing the sensor deploying mechanism to deploy the sensor in accordance with the sensor position calculated by the sensor position calculating section,

in which the sensor deployment controlling section causes the sensor deploying mechanism to deploy the sensor in accordance with the generated instruction information.

(3)

The farm field management system as stated in paragraph (1) or (2) above, further including:

a sensor communication section configured to communicate with the sensor deployed by the sensor deploying mechanism in order to acquire a sensor ID of the sensor.

(4)

The farm field management system as stated in paragraph (3) above, further including:

a log generating section configured to generate a sensor deployment log including the sensor ID of the sensor in communication and a sensor deployment position at which the sensor is deployed.

(5)

The farm field management system as stated in paragraph (4) above, in which the sensor deployment log includes a timestamp indicative of a date and a time at which the sensor has been deployed and a sensor type indicative of the deployed sensor.

(6)

The farm field management system as stated in paragraph (4) or (5) above, further including:

a storage section configured to store the generated sensor deployment log.

(7)

The farm field management system as stated in any one of paragraphs (1) to (6) above, further including:

a farm machine configured to have a farm machine mount sensor for acquiring the farm field information on the farm field; and

an implement configured to be connected with the farm machine and include the sensor deploying mechanism,

in which the sensor position calculating section calculates the sensor position following the acquisition of the farm field information by the farm machine mount sensor of the farm machine, and

the sensor deployment controlling section causes the sensor deploying mechanism of the implement to deploy the sensor following the calculation of the sensor position by the sensor position calculating section.

(8)

The farm field management system as stated in paragraph (7) above, in which the farm machine mount sensor acquires as the farm field information image data representing a crop as an object, and

the sensor position calculating section calculates the sensor position based on a positional relation between the crop on the one hand and the farm machine and the implement on the other hand, the positional relation being calculated through analysis of the image data.

(9)

The farm field management system as stated in paragraph (7) above, in which the farm machine mount sensor acquires as the farm field information data about moisture and nutrients in the soil, and

the sensor position calculating section calculates the sensor position based on the data about the moisture and the nutrients.

(10)

The farm field management system as stated in any one of paragraphs (1) to (9) above, further including:

a seeding position calculating section configured to calculate a seeding position for a crop on the farm field on the basis of the farm field information.

(11)

The farm field management system as stated in paragraph (10) above, further including:

a seeding mechanism configured to seed the crop in accordance with the seeding position in parallel with the deployment of the sensor by the sensor deploying mechanism.

(12)

The farm field management system as stated in paragraph (11) above, further including:

a log generating section configured to generate a seeding log including a crop ID of the seeded crop and the seeding position at which the crop has been seeded.

(13)

The farm field management system as stated in any one of paragraphs (1) to (12) above, further including:

a display section configured to display a screen indicative of deployment status of the sensor on the farm field.

(14)

The farm field management system as stated in paragraph (13) above, in which the display section updates the display on the screen every time the sensor is deployed.

(15)

The farm field management system as stated in paragraph (1) above, in which the sensor includes

a sensor substrate configured to communicate with the sensor communication section,

a capsule configured to be spherical in shape to encapsulate the sensor substrate, and

a weight configured to be disposed inside the capsule to keep the sensor substrate constant in attitude.

(16)

A farm field management method including the steps of:

calculating a sensor position at which a sensor is deployed on a farm field on the basis of farm field information; and

controlling a sensor deploying mechanism that deploys the sensor on the farm field to deploy the sensor in accordance with the sensor position.

(17)

A farm equipment system, in which

an information processing apparatus includes a sensor position calculating section configured to calculate a sensor position at which a sensor is deployed on a farm field on the basis of farm field information; and

an implement includes a sensor deployment controlling section configured to control a sensor deploying mechanism that deploys the sensor on the farm field to deploy the sensor in accordance with the sensor position.

### REFERENCE SIGNS LIST

1 Farm field management system
10 Farm field
20 Sensor
21 Capsule
22 Sensor substrate
23 Weight
40 Farm equipment system
41 Farm machine
42 Implement
50 Mobile object
60 Terminal apparatus
70 Repeater
80 Server
111 Control console
114 Position information acquiring section
122 Implement mechanism
123 Sensor communication section
161 Control section
172 Sensor position calculating section
173 Work instruction information generating section
174 Log generating section
181 Control section
184 Sensor deploying mechanism
191 Sensor deployment controlling section
192 Sensor communication controlling section
211 Control section
221 Control section
311 Work mechanism
321 Work controlling section
331 Control section
335 Position information acquiring section
336 Sensor communication section
341 Route information generating section
351 Status estimating section
352 Work information generating section
361 Sensor communication section
411 Power generating section
412 Power storage device
413 Status transition section
414 Communication module
501 Wireless communication system
510 Communication apparatus
511 Sensor communication section
511a, 511b, 511c Antenna
512 Communication controlling section
513 Distance calculating section
520 Sensor
532 Frequency setting section
541 Radiating direction setting section
551 Transmission power setting section
561 Status setting section
611 Route information generating section
612 Unrecovered sensor identifying section
622 Sensor recovering mechanism
631 Sensor recovery controlling section

1. A farm field management system comprising:
a sensor position calculating section configured to calculate a sensor position at which a sensor is deployed on a farm field on the basis of farm field information; and
a sensor deployment controlling section configured to control a sensor deploying mechanism that deploys the sensor on the farm field to deploy the sensor in accordance with the sensor position.

2. The farm field management system according to claim 1, further comprising:
an instruction information generating section configured to generate instruction information for causing the sensor deploying mechanism to deploy the sensor in accordance with the sensor position calculated by the sensor position calculating section,
wherein the sensor deployment controlling section causes the sensor deploying mechanism to deploy the sensor in accordance with the generated instruction information.

3. The farm field management system according to claim 1, further comprising:
a sensor communication section configured to communicate with the sensor deployed by the sensor deploying mechanism in order to acquire a sensor ID of the sensor.

4. The farm field management system according to claim 3, further comprising:
a log generating section configured to generate a sensor deployment log including the sensor ID of the sensor in communication and a sensor deployment position at which the sensor is deployed.

5. The farm field management system according to claim 4, wherein the sensor deployment log includes a timestamp indicative of a date and a time at which the sensor has been deployed and a sensor type indicative of the deployed sensor.

6. The farm field management system according to claim 4, further comprising:
a storage section configured to store the generated sensor deployment log.

7. The farm field management system according to claim 1, further comprising:
a farm machine configured to have a farm machine mount sensor for acquiring the farm field information on the farm field; and
an implement configured to be connected with the farm machine and include the sensor deploying mechanism,
wherein the sensor position calculating section calculates the sensor position following the acquisition of the farm field information by the farm machine mount sensor of the farm machine, and
the sensor deployment controlling section causes the sensor deploying mechanism of the implement to deploy the sensor following the calculation of the sensor position by the sensor position calculating section.

8. The farm field management system according to claim 7, wherein the farm machine mount sensor acquires as the farm field information image data representing a crop as an object, and
the sensor position calculating section calculates the sensor position based on a positional relation between the crop on the one hand and the farm machine and the implement on the other hand, the positional relation being calculated through analysis of the image data.

9. The farm field management system according to claim 7, wherein the farm machine mount sensor acquires as the farm field information data about moisture and nutrients in the soil, and
the sensor position calculating section calculates the sensor position based on the data about the moisture and the nutrients.

10. The farm field management system according to claim 1, further comprising:
a seeding position calculating section configured to calculate a seeding position for a crop on the farm field on the basis of the farm field information.

11. The farm field management system according to claim 10, further comprising:
a seeding mechanism configured to seed the crop in accordance with the seeding position in parallel with the deployment of the sensor by the sensor deploying mechanism.

12. The farm field management system according to claim 11, further comprising:
a log generating section configured to generate a seeding log including a crop ID of the seeded crop and the seeding position at which the crop has been seeded.

13. The farm field management system according to claim 1, further comprising:
a display section configured to display a screen indicative of deployment status of the sensor on the farm field.

14. The farm field management system according to claim 13, wherein the display section updates the display on the screen every time the sensor is deployed.

15. The farm field management system according to claim 1, wherein the sensor includes
a sensor substrate configured to communicate with the sensor communication section,
a capsule configured to be spherical in shape to encapsulate the sensor substrate, and
a weight configured to be disposed inside the capsule to keep the sensor substrate constant in attitude.

16. A farm field management method comprising the steps of:
calculating a sensor position at which a sensor is deployed on a farm field on the basis of farm field information; and
controlling a sensor deploying mechanism that deploys the sensor on the farm field to deploy the sensor in accordance with the sensor position.

17. A farm equipment system, wherein
an information processing apparatus includes a sensor position calculating section configured to calculate a sensor position at which a sensor is deployed on a farm field on the basis of farm field information; and
an implement includes a sensor deployment controlling section configured to control a sensor deploying mechanism that deploys the sensor on the farm field to deploy the sensor in accordance with the sensor position.
